(19) United States
(12) Patent Application Publication
(10) Pub. No.: US 2026/0297458 A1
(43) Pub. Date: Oct. 1, 2026

(54) LAUNDRY SANITIZING COMPOSITIONS

(71) Applicant: Reckitt Benckiser LLC, Parsippany, NJ (US)

(72) Inventors: Marcella BONESSO, Mira (IT); Andre CHIEFFI, Mira (IT); Giulia COLLEDAN, Mira (IT); Joseph Frederick CONVERY, Ringwood, NJ (US); Anna DEL MONACO, Mira (IT); Santigie MANSARAY, Montvale, NJ (US); Remigio MUSCI, Mira (IT); Federico PACINI, Mira (IT); Benjamin Aaron PEARL, Morristown, NJ (US); Antonio Vincenzo PETROZZINO, Wayne, NJ (US); Tracy Ann RYAN, Montvale, NJ (US); Anna Kepa SIGMUND, Mahwah, NJ (US); Alberto SIMIONATO, Mira (IT); Alessandra TRAVANUT, Mira (IT); Elisa VANZETTO, Mira (IT); Stephanie Kaitlyn YIU, Ridgewood, NJ (US)

(21) Appl. No.: 19/477,230

(22) PCT Filed: Apr. 22, 2024
(86) PCT No.: PCT/EP2024/060887

§ 371 Date: Oct. 21, 2025

(30) Foreign Application Priority Data
Apr. 21, 2023 (GB) 2305899.3

(51) Int. Cl. C11D 1/62; C11D 3/20; C11D 3/37; C11D 3/382; C11D 3/386

(52) U.S. Cl. CPC C11D 1/62; C11D 3/2086; C11D 3/3707; C11D 3/373; C11D 3/382; C11D 3/38636; C12Y 301/04001

(57) ABSTRACT

Compositions are disclosed comprising approximately 2% wt to approximately 4% wt of a benzyl-substituted quaternary ammonium compound and three or more pH adjusters. The pH adjusters are selected from citric acid, sodium citrate, an alkali hydroxide, an alkali carbonate, or any combinations thereof. The disclosed compositions are substantially free of dialkyl dimethyl ammonium chloride. The disclosed compositions provide improved reduction in bacteria and viruses during the last rinse cycle of an automatic laundry machine while also providing fabric protection.

### CROSS REFERENCE TO RELATED APPLICATIONS

This application claims priority PCT/EP2024/060887 filed 22 Apr. 2024, which in turn claims priority to GB patent application number 2305899.3, filed 21 Apr. 2023, the contents of each of which are incorporated herein by reference in their entirety.

### TECHNICAL FIELD

Compositions are disclosed comprising approximately 2% wt to approximately 4% wt of a benzyl-substituted quaternary ammonium compound and three or more pH adjusters. The pH adjusters are selected from citric acid, sodium citrate, an alkali hydroxide, an alkali carbonate, or combinations thereof. The disclosed compositions are substantially free of dialkyl dimethyl ammonium chloride. The disclosed compositions provide improved reduction in bacteria and viruses during the last rinse cycle of an automatic laundry machine. The disclosed compositions may also provide other benefits, such as fabric protection.

### BACKGROUND

Consumers have increased interest in washing laundry under energy and water efficient conditions due to environmental concerns. Consumers also have increased interest in washing with reduced environmental impact. For example, some consumers use less environmentally harmful laundry detergents and fabric softeners. Consumers are also interested in washing laundry at cooler temperatures, with less water, and with milder laundry formulations. Washing laundry under these conditions raises concerns that the resulting items may be visibly clean but may be unhygienic because they may still harbor pathogens. Therefore, there is a growing demand for laundry sanitizing compositions to ensure that clean laundry harbors fewer pathogens. However, laundry sanitizing compositions are added to the fabric softener drawer of the washing machine, making it difficult to use both laundry sanitizing compositions and fabric softener compositions in the same wash cycle.

Lysol® Laundry Sanitizer (LLS) is a commercially available product that is used for sanitizing clean laundry. LLS contains the dialkyl (C₈₋₁₀) dimethylammonium chloride (DDAC), benzyl-C₁₂₋₁₈-alkyldimethyl ammonium chloride (ADBAC), and an alcohol alkoxylate nonionic surfactant. About 150 mL of LLS is added to the fabric softener drawer of the top-load washing machine for use in the washing machine rinse cycle (100 mL is added for front-loaders). LLS kills 99.9% of bacteria (i.e., a 3-log 10 reduction in bacteria) in laboratory tests.

WO2023/036940 to Rhodia Operations discloses an antimicrobial composition comprising a first antimicrobial agent selected from the group consisting of benzalkonium salts, trilocarban, diclosan, triclosan, or combinations thereof, and a second antimicrobial agent which is a cationic polymer (known as polyquaternium 2) having a weight average molecular weight of 1,000 to 50,000 represented by the general formula (I):

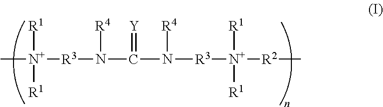

US2022/233411 to Godrej Consumer Products Ltd discloses a reconstitutable sanitizer formulation which is non-alcoholic in nature and achieves up to 99.9% reduction in microbial load and provides long-lasting protection against microbes for 2-6 hours.

WO2021/156297 to Arch UK Biocides Ltd discloses laundry sanitizing compositions containing a biocide agent and an acidic buffering system.

WO2020/168046 to Rhodia Operations discloses microbial compositions that include an antimicrobial component having at least one quaternary ammonium compound; a synthetic polymer, such as PQ5, PQ7, PQ11, or PQ28; an organic acid; a surfactant selected from cationic surfactants, amphoteric surfactants, and combinations thereof; and at least one non-ionic surfactant.

WO2019/015839 to Henkel AG & Co. KGAA discloses aqueous cleaning agents comprising at least one cationic surfactant comprising at least one quaternary ammonium compound, at least one nonionic surfactant comprising at least one amine oxide, at least one alcohol, optional additives, and water.

WO2018/108466 to Unilever PLC discloses a biocidal composition comprising one or more water soluble quaternary ammonium compounds and one or more water soluble organic hydroxy acids. 2 to 100 mL of the composition is added to the rinse aid dispenser of an automatic washing machine, optionally together with a dose of liquid fabric conditioner in the same dispensing compartment.

WO2014/092693 to Colgate-Palmolive Company discloses a composition comprising a cationic surfactant and an esterquat that is a quaternized reaction product of an alkanol amine and a fatty acid wherein from at least 90 wt % to up to 100 wt % of the esterquat is comprised of triesterquat and from 0 wt % to up to 10 wt % of the esterquat is comprised of at least one of monoesterquat and diesterquet. The composition may be used to soften fabric or increase fragrance delivery.

WO2013/124784 to BASF (China) Company Limited discloses compositions comprising a) an antimicrobial agent selected from the group consisting of biocides containing halogen atoms and/or containing phenolic moieties, formic acid, chlorine dioxide, chlorine dioxide generating compounds, dialdehydes, components containing an antimicrobial metal, such as antimicrobial metal, and b) a polymine, especially polyethyleneimine.

WO2013/017967 to Kimberly-Clark Worldwide Inc. discloses antimicrobial cleansing compositions including a polar carrier solvent, a cationic compatible surfactant, a quaternary ammonium biocide, and a cationic compatible afterfeel agent.

WO2012/090100 to Kimberly-Clark Worldwide, Inc. discloses durable antimicrobial compositions comprising a carbonate/bicarbonate salt of a quaternary ammonium cation, an organic acid, hydrogen peroxide and a cationic polymer, namely

WO2012/080918 to Ecolab USA Inc discloses anti-microbial compositions comprising a quaternary ammonium compound and a cationic biocide.

WO2011/149475 to Colgate-Palmolive Company discloses a composition comprising an esterquat that is a quaternized reaction product of an alkanol amine and a fatty acid. Methods of softening fabric and increasing fragrance delivery by treating fabric with the compositions are also disclosed.

WO2007/104387 to Hindustan Unilever Ltd discloses a fabric conditioner composition comprising 0.1-20% by weight cationic fabric conditioner active, 0.1-10% organic acid having 1 to 8 carbon atoms, and 0.1-5% anion quencher selected from a mono-long chain quaternary ammonium compound having the formula R(R¹)₃N⁺X⁻, wherein R is C8-22 alkyl or alkenyl, R1 is a C1-C3 alkyl, and X⁻ is an anionic selected from chloride, bromide iodide, nitrate, sulfate, methyl sulfate, ethyl sulfate, acetate, ad phosphate, or an alkyl benzyl quaternary ammonium compound having the formula R²R³(R⁴)₂N⁺X⁻, wherein R² is a C6-18 alkyl or alkenyl group, R³ is a benzyl group, and R⁴ is a C1-C3 alkyl group.

WO2006/094582A1 to Unilever PLC discloses aqueous fabric softening compositions having good high temperature stability comprising a cationic fabric softening compound and water soluble polysaccharide polymers.

US2005/037944 to Grandmaire et al. discloses a medium viscosity, clear fabric softening composition comprising form about 1 to 20 wt % of an oligomeric esterquat, at least about 0.2% wt dipropylene glycol, an effective amount of a water insoluble perfume, and an effective amount of a thickening agent to provide a viscosity of from 80 to 700 m·Pas.

WO2002/072745 to The Procter & Gamble Company discloses a rinse added composition for the conditioning of fabric in a rinse, the composition comprising a fabric softener active, a suds suppressing system, and a surfactant scavenger.

WO2001/30951 to Reckitt Benckiser France discloses a washing and conditioning method using, in the main wash, one or more cleansing surfactants and one or more organic quaternary ammonium polymers.

EP1149891 to Goldschmidt Chemical Company discloses a low cost fabric softener for rinse cycle comprising a blend of a triglyceride-based ester quat and quaternary ammonium anionic scavenger.

WO 96/21715 to The Procter & Gamble Company discloses concentrated liquid fabric softener compositions stabilized by means of water-soluble polyesters.

U.S. Pat. No. 4,476,030 to Hoescht Aktiengesellschaft discloses concentrated masterbatches of fabric softeners.

U.S. Pat. No. 3,349,033 to Zuccarelli discloses stable laundry softeners having microbiologically active properties.

There remains a need for laundry compositions that provide germ kill and other benefits during a laundry rinse cycle, while being safer for the environment.

### SUMMARY OF INVENTION

Disclosed are compositions comprising approximately 2% wt to approximately 4% wt of a benzyl-substituted quaternary ammonium compound and three or more pH adjusters, the pH adjusters being selected from the group consisting of citric acid, sodium citrate, an alkali hydroxide, and combinations thereof. The disclosed compositions are substantially free of dialkyl dimethyl ammonium chloride. The disclosed compositions may include one or more of the following aspects:
the composition comprising three or more pH adjusters;
the composition being a laundry composition;
the laundry composition being a biocide;
the laundry composition being a sanitizer;
the laundry composition being a softener;
the laundry composition being a conditioner;
the laundry composition being a fabric protector;
the laundry composition being a fabric protector and biocide;
the laundry composition being a fabric protector and sanitizer;
the laundry composition being a softener and biocide;
the laundry composition being a softener and sanitizer;
the laundry composition being a conditioner and biocide;
the laundry composition being a conditioner and sanitizer;
the laundry composition comprising only one benzyl-substituted quaternary ammonium compound;
the benzyl-substituted quaternary ammonium compound being substantially free of ester ligands;
the benzyl-substituted quaternary ammonium compound being substantially free of alkoxy ligands;
the benzyl-substituted quaternary ammonium compound being C12-18 alkyl dimethyl benzyl ammonium chloride;
the benzyl-substituted quaternary ammonium compound being C12-16 alkyl dimethyl benzyl ammonium chloride;
the composition comprising between approximately 2.25% wt and approximately 2.75% wt benzyl-substituted quaternary ammonium compound;
the composition comprising between approximately 2.25% wt and approximately 2.75% wt C12-18 alkyl dimethyl benzyl ammonium chloride;
the composition comprising between approximately 2.25% wt and approximately 2.75% wt C12-16 alkyl dimethyl benzyl ammonium chloride;
the composition comprising between approximately 4% wt to approximately 6% citric acid;
the composition comprising between approximately 4.5% wt to approximately 5.5% citric acid;
the composition comprising between approximately 0.8% wt to approximately 2% wt sodium citrate;
the composition comprising between approximately 1% wt to approximately 1.5% wt sodium citrate;
the composition comprising between approximately 0.005% wt and approximately 0.03% wt of the alkali hydroxide or alkali carbonate;
the alkali hydroxide being sodium hydroxide;
the alkali hydroxide being potassium hydroxide;
the alkali carbonate being sodium carbonate, sodium bicarbonate, potassium carbonate, potassium bicarbonate, or combinations thereof;
the composition comprising between approximately 0.005% wt and approximately 0.03% wt of sodium hydroxide;
the composition comprising between approximately 0.005% wt to approximately 0.01% wt sodium hydroxide;
further comprising water;
further comprising approximately 85% wt to approximately 95% wt water;
the water comprising less than 17 ppm of calcium and magnesium;
the composition being a liquid;
the composition having a viscosity ranging from approximately 1000 cPs to approximately 2500 cPs as measured on the Brookfield™ DVII+ viscometer equipped with a temperature regulated disposable sample chamber using a SC4-31 spindle after 180 seconds at 12 RPM at 20° C.;
the composition being a single-phase liquid at room temperature;
the composition being a clear single-phase liquid at room temperature;
the composition being an opaque single-phase liquid at room temperature;
the composition further comprising encapsulated fragrances and being a suspension at room temperature;
the single-phase liquid composition being acidic;
the composition having a pH at 20° C. ranging from approximately 2 to approximately 4;
the composition having a pH at 20° C. ranging from approximately 2.5 to approximately 3;
further comprising a polysaccharide or cellulose based material;
the cellulose based material being a thickener;
the cellulose based material being a suspending agent;
the cellulose based material being a softener;
further comprising two or more polysaccharide or cellulose based materials;
the composition comprising approximately 0.1% wt and approximately 2% wt polysaccharide or cellulose based material;
the composition comprising approximately 0.6% wt and approximately 1.8% wt polysaccharide or cellulose based material;
the polysaccharide or cellulose based material being carboxymethyl cellulose, hydroxyethylcellulose, hydropropylmethylcellulose, methylhydroxyethylcellulose, a fermentation derived cellulose, or combinations thereof;
the cellulose based material being hydroxyethylcellulose;
the cellulose based material being hydroxyethylcellulose sold by Dow under the tradename Cellosize™ QP100;
a 1% wt solution of the cellulose based material in water having a viscosity ranging from approximately 4,400 cPs to approximately 6,000 cPs as measured using a Brookfield viscometer at 25° C.;
the cellulose based material having a bulk density ranging from approximately 0.3 g/cm³ to approximately 0.6 g/cm³;
the cellulose based material being methylhydroxyethylcellulose;
the cellulose based material being methylhydroxyethylcellulose sold by Dow under the tradename SupraCare™ 780;
a 1% wt solution of the cellulose based material in water having a viscosity ranging from approximately 12,000 cPs to approximately 16,000 cPs as measured using a Haake Roto Visco RV 100 with a shear rate of 2.55 S⁻¹ at 20° C.;
a 1% wt solution of the cellulose based material in water having a pH ranging from approximately 6 to approximately 7 at 20° C.;
the cellulose based material being a fermentation derived cellulose;
the cellulose based material being a fermentation derived cellulose sold by CP Kelco under the tradename Cellulon™ RC-76;
the cellulose based material being a fermentation derived cellulose sold by CP Kelco under the tradename Cellulon™ R93;
further comprising stearyldimonium hydropropyl hydrolyzed wheat protein;
further comprising stearyldimonium hydropropyl hydrolyzed wheat protein sold by Croda under the tradename Coltide™ HQS;
the composition comprising approximately 0.05% wt to approximately 2% wt of the stearyldimonium hydropropyl hydrolyzed wheat protein sold by Croda under the tradename Coltide™ HQS;
the composition comprising approximately 0.1% wt to approximately 1% wt, of the stearyldimonium hydropropyl hydrolyzed wheat protein sold by Croda under the tradename Coltide™ HQS;
further comprising a copolymer of hydrolysed wheat protein and silicone;
further comprising a copolymer of hydrolysed wheat protein and silicone sold by Croda under the tradename Coltide™ HSi;
the composition comprising approximately 0.05% wt to approximately 2% wt of the copolymer of hydrolysed wheat protein and silicone sold by Croda under the tradename Coltide™ HSi;
the composition comprising approximately 0.1% wt to approximately 1% wt of the copolymer of hydrolysed wheat protein and silicone sold by Croda under the tradename Coltide™ HSi;
the composition comprising approximately 0.05% wt to approximately 2% wt of the quaternised hydrolysed wheat protein/silicone copolymer sold by Croda under the tradename Coltide™ Radiance;
the composition comprising approximately 0.1% wt to approximately 1% wt of the quaternised hydrolysed wheat protein/silicone copolymer sold by Croda under the tradename Coltide™ Radiance;
further comprising a polysaccharide;
the polysaccharide being a blend of hydropropylmethylcellulose, xanthan gum, and cetyl-hydroxy ethyl cellulose;
the polysaccharide being a blend of hydropropylmethylcellulose, xanthan gum, and cetyl-hydroxy ethyl cellulose sold by Ashland under the tradename Ecothix™;
the composition comprising between approximately 0.1% wt to approximately 1% wt of the polysaccharide;
an initial viscosity ranging from approximately 1000 cPs to approximately 2500 cPs as measured on the Brookfield™ DVII+ viscometer equipped with a temperature regulated disposable sample chamber using a SC4-31 spindle after 180 seconds at 12 RPM at 20° C.;
the viscosity remaining within approximately 50% to 90% of the initial viscosity over approximately 2 years time;
the viscosity remaining within approximately 65% to 85% of the initial viscosity over approximately 2 years time;
further comprising a liquid ethoxyquat;
further comprising a non-polymeric alkoxy quaternary ammonium salt;
the liquid non-polymeric alkoxy quaternary ammonium salt being N,N′-di(alkylcarboxyethyl)-N-hydroxyethyl-N-methylammonium sulfate;
the liquid non-polymeric alkoxy quaternary ammonium salt being a fabric protector;
further comprising a non-ionic surfactant;
the non-ionic surfactant being an alkylamine oxide;
the composition comprising approximately 0.3% wt to approximately 1.5% wt alkylamine oxide;
the composition comprising between approximately 0.4% wt to approximately 1% wt of an alkylamine oxide;
the composition comprising approximately 0.3% wt to approximately 1.5% wt C10-14 alkylamine oxide;
the composition comprising between approximately 0.4% wt to approximately 1% wt of a C10-14 alkylamine oxide;
the composition comprising between approximately 0.3% wt to approximately 1.5% wt of a lauramine oxide;
the composition comprising between approximately 0.4% wt to approximately 1% wt of a lauramine oxide;
the composition comprising between approximately 0.3% wt to approximately 1.5% wt of a decyl amine oxide;
the composition comprising between approximately 0.4% wt to approximately 1% wt of a decyl amine oxide;
further comprising phenoxyethanol;
further comprising approximately 0.4% wt to approximately 1% wt phenoxyethanol;
the composition comprising between approximately 0.45% wt to approximately 0.75% wt of phenoxyethanol;
further comprising a carrier solvent;
the carrier solvent being methanediol, 1,2-propanediol, 1,3-propanediol, 1,2-butanediol, 1,3-butanediol, 1,4-butanediol, 2,3-butanediol, polyethyelene glycol, polypropylene glycol, glycerin, water, or combinations thereof;
the carrier solvent being 1,2-propanediol, 1,3-propanediol, glycerin, water, and combinations thereof;
the composition comprising between approximately 0.1% wt to approximately 1% wt of a non-aqueous carrier solvent;
the composition comprising between approximately 0.25% wt to approximately 0.75% wt of a non-aqueous carrier solvent;
further comprising an opacifier;
the composition comprising between approximately 0.1% wt to approximately 0.5% wt opacifier;
further comprising a polymer to suspend the opacifier;
the polymer being poly(2-methacryloxyethyltrimethylammonium chloride);
the polymer being poly(diallylmethylammonium chloride);
the composition comprising between approximately 0.25% wt to approximately 3% wt polymer;
the composition comprising between approximately 0.5% wt to approximately 2.5% wt polymer;
further comprising a polymer to enhance microefficacy;
the selected from the group consisting of polymer being poly(diallyldimethylammonium chloride) (PQ6) having a molecular weight <100 kDa (PQ6<100 kDa); PQ6 having a molecular weight ranging from 200 kDa to 300 kDa (PQ6 200-300 kDa); PQ6 having a molecular weight ranging from 400 kDa to 500 kDa (PQ6 400-500 kDa); copolymers of vinylpyrrolidone (VP) and quaternized vinylimidazole (QVI) (PQ16) having 5% wt VP and 95% wt QVI (PQ16 5VP-95QVI); PQ16 having 50% wt VP and 95% wt QVI (PQ16 50VP-50QVI); Poly(2-dimethylamino)ethyl methacrylate) methyl chloride quaternary salt (PQ37); 1-propanaminium, N,N,N-trimethyl-3-[(1-oxo-2-propenyl)amino] chloride, homopolymer (A1000); 1-dodecanaminium, N,N-dimethyl-N-[3-[(2-methyl-1-oxo-2-propen-1-yl)amino]propyl]-, chloride (1:1), polymer with sodium 2-methyl-2-[(1-oxo-2-propen-1-yl)amino]-1-propanesulfonate (1:1) and N,N, N-trimethyl-3-[(1-oxo-2-propen-1-yl)amino]-L propanaminium chloride (1:1) (C113); and combinations thereof;
the polymer being PQ6<100 kDa, PQ6 200-300 kDa, PQ6 400-500 kDa, PQ16 5VP-95QVI, A1000, C113, or combinations thereof;
the polymer being PQ6<100 kDa, PQ6 200-300 kDa, or combinations thereof;
the polymer being PQ6<100 kDa;
the polymer being PQ6 200-300 kDa;
the polymer being PQ6 400-500 kDa;
the polymer being PQ16 5VP-95QVI;
the polymer being PQ16 50VP-50QVI;
the polymer being PQ37;
the polymer being A1000;
the polymer being C113;
the composition being substantially free of a polymer selected from the group consisting of poly(acrylamide-co-diallyldimethylammonium chloride (PQ7), copolymers of vinylpyrrolidone and quaternized vinylimidazole having more vinylpyrrolidone units than quaternized vinylimidazole units (PQ16 70VP-30QVI), 2-pyrrolidinone, 1-ethenyl-polymer with N,N,N-trimethyl-3-[(2-methyl-1-oxo-2-propenyl)amino]-1-propanium chloride (PQ28), and combinations thereof;
the composition being substantially free of betaine surfactants the composition being substantially free of enzymes;
the composition being substantially free of dialkyl dimethyl ammonium chloride;
the composition being substantially free of a copolymer of acrylamide and diallyldimethylammonium chloride;
the composition being substantially free of an added electrolyte, such as sodium chloride;
the composition being substantially free of chelant;
the composition being substantially free of anionic surfactant;
the composition being substantially free of alkanolamine, such as monoethanolamine, diethanolamine, triethanolamine, or combinations thereof;
the composition being substantially free of glycol ether;
the composition being substantially free of peroxide;
the composition being substantially free of hydrogen peroxide;
the composition being substantially free of bisguanide;
the composition being substantially free of guanide;
the composition being substantially free of added alcohol;
the composition being substantially free of added ethanol;
the composition being substantially free of a copolymer of vinylpyrrolidone and quaternized vinylimidazole;
the composition being substantially free of an unsaturated fatty alcohol;
the composition comprising between approximately 0.25% wt and approximately 2% wt of amine oxides;
the composition comprising between approximately 0.5% wt and approximately 3% wt of polyquaternium-6;
the composition comprising between approximately 1% wt and approximately 3% wt of ethylene glycol monohexyl ether.

Also disclosed are methods of sanitizing and conditioning fabrics. Any of the compositions disclosed above are diluted with water to produce a diluted composition. The fabric to be treated is contacted with the diluted composition. The disclosed methods may include one or more of the following aspects:
adding 225 mL of any of the compositions disclosed above to the rinse aid dispenser of a top loader (47 L H2O);
adding 150 mL of any of the compositions disclosed above to the rinse aid dispenser of a top loader (47 L H2O);
adding 100 ml of any of the compositions disclosed above to the rinse aid dispenser of a front loader (17 L H2O); and
adding 75 mL of any of the compositions disclosed above to one gallon water in a bucket for pre-soak.

### Terms and Definitions

As used herein:
the symbol “~” and the terms “approximately” and “about” mean plus or minus 10% of the value stated;
the term “a” or “an” means one or more;
any and all ranges are inclusive of their endpoints, e.g., ranging from 1 wt % to 10 wt % wt includes 1 wt % and 10 wt % and any concentration between 1 wt % and 10 wt %;
all amounts given in % are % by weight (wt %) unless otherwise stated. When a raw material does not contain close or equal to 100% active material, two percentages may be provided: one for the weight of the raw material and one for the weight of the active. For example, 7.28% wt of BTC™ 1218 contains approximately 80% benzalkonium chloride in water, alcohol and/or polypropylene glycol, which equates to approximately 5.82% wt of benzalkonium chloride in the composition. This would be represented as 7.28% wt (5.82% wt) BTC™ 1218;
the term “benzyl group” is C₆H₅CH₂—;
the term “comprising” is inclusive or open-ended and does not exclude any additional elements; the term “consisting of” excludes any additional elements; and the term “consisting essentially of” is in-between, only permitting additional elements that do not materially affect characteristics of the product or process;
the phrase “substantially free” means a concentration of less than 0.3% wt, preferably less than 0.2% wt, more preferably less than 0.1% wt, and most preferably less than 0.05% wt;
the abbreviation “q.s.” is short for the Latin term quantum satis which means the amount of which is enough and, as used herein, means the amount of water needed to bring the formulation to 100% wt.;
the terms “germ” and “microbe” or “microbial” means microorganisms which causes disease or undesirable effects, such as malodor, and encompasses both bacteria and viruses;
the terms “disinfect” or “disinfection” mean no growth observed during the micro testing;
the terms “sanitize” or “sanitizer” mean to reduce the level of bacteria (note, not viruses) on a surface to a level that is considered “safe” but not total kill;
the terms “biocide” or “biocidal” mean any product that can kill germs, including bacteria and viruses; biocides are substances approved to kill microorganisms and typically registered with a governing body (i.e., the US Environmental Protection Agency or the European Chemical Agency (ECHA));
the term “liquid” means a state of matter that conforms to the shape of the container in which it is held at room temperature (18-23° C.) and which acquires a defined surface in the presence of gravity; the term “liquid” is readily distinguishable from the terms “solid” and “gas.” Liquids are not pastes, which behaves as a solid until a sufficiently large load or stress is applied, even though a paste is also known as a Bingham plastic fluid;
the term “alone” means that no other ingredients are present, in other words, the stated ingredient is the only ingredient;
the term “ambient temperature” means room temperature which may vary depending on the season from approximately 18° C. to approximately 28° C., but preferably from approximately 20° C. to approximately 25° C.

### DETAILED DESCRIPTION

Compositions are disclosed comprising approximately 2% wt to approximately 4% wt of a benzyl-substituted quaternary ammonium compound and three or more pH adjusters. The pH adjusters being are selected from citric acid, sodium citrate, an alkali hydroxide, an alkali carbonate, or any combinations thereof. The disclosed compositions are substantially free of dialkyl dimethyl ammonium chlorides.

The disclosed compositions may be used in laundry formats, such as a laundry biocide, a laundry sanitizer, a laundry softener, a laundry conditioner, a laundry fabric protector, or combinations thereof. Preferably, the disclosed compositions may serve two or more functions. For example, the disclosed composition may be a fabric protector and biocide, or a fabric protector and sanitizer, or a softener and biocide, or a softener and sanitizer, or a conditioner and biocide, or a conditioner and sanitizer. Alternatively, the disclosed composition may be a fabric protector and softener and conditioner. Alternatively, the disclosed composition may be a biocide and sanitizer.

The disclosed compositions reduce and/or remove germs during the last rinse cycle of a laundry machine washing process. The disclosed compositions also reduce and/or remove malodor containing bacteria during the last rinse cycle of a laundry machine washing process. The disclosed compositions remain stable over time.

Industry leaders have predominantly utilized quaternary ammonium compounds (quats) in order to provide consumers with a germ kill benefit. Quats are typically cheap, readily available, and offer a satisfactory level of disinfection to the consumer. Despite these benefits, quats are known to be toxic to aquatic environments with potential long-lasting effects. Even though quats are expected to biodegrade, regulatory bodies (e.g., the US Environmental Protection Agency) may prohibit individuals from making biodegradability claims if these compounds are present in any amount.

The disclosed compositions comprise a low concentration of quats, but are still able to obtain germ kill when diluted during the last rinse cycle of an automatic clothes washing process. The disclosed compositions comprise approximately 2% wt to approximately 4% wt of a benzyl-substituted quaternary ammonium compound, preferably between approximately 2.25% wt and approximately 2.75% wt. Benzyl-substituted quaternary ammonium compounds have the formula: C₆H₅CH₂NR₃⁺X⁻, wherein each R is independently a C1-C18 hydrocarbon group and X is an alkali metal, saccharinate group, or carbonate group. R is not an ether or alkoxy group. A C1-3 alkyl group may also be linked to the benzyl ring (e.g., ethylbenzyl C12-18 dimethyl benzyl ammonium chloride). Preferably the benzyl-substituted quaternary ammonium compound has the formula C₆H₅CH₂N(CH₃)₂R⁺X⁻, wherein R is a C12-C18 or C12-C16 alkyl group and X is Cl.

To achieve germ kill with the low level of quat, the disclosed composition comprises three or more pH adjusters: citric acid, sodium citrate, an alkali hydroxide, an alkali carbonate, or any combination thereof. The pH adjusters adjust the pH of the disclosed compositions to a range from approximately 2 to approximately 4 at 20° C., preferably from approximately 2.5 to approximately 3. As a result, the disclosed compositions are acidic. This pH range provides improved antimicrobial efficacy to the benzyl-substituted quaternary ammonium compounds. This pH range may also contribute to improved limescale removal as compared compositions at higher pH ranges. Limescale traps dirt, odors, and germs. As a result, the removal of limescale at pH 2-4 provides heightened freshness of the fabrics.

The disclosed compositions comprise between approximately 4% wt to approximately 6% citric acid, preferably between approximately 4.5% wt to approximately 5.5% citric acid. One of the many functions of citric acid is a chelant. As a result, the disclosed compositions may be substantially free of any additional chelant besides the citric acid, such as EDTA, GLDA, etc.

The disclosed compositions comprise between approximately 0.8% wt to approximately 2% wt sodium citrate, preferably between approximately 1% wt to approximately 1.5% wt sodium citrate. Sodium citrate may be either tri sodium citrate dihydrate or tri sodium citrate anhydrous.

The disclosed compositions comprise between approximately 0% wt and approximately 0.03% wt of the alkali hydroxide or alkali carbonate, preferably between approximately 0.005% wt to approximately 0.01% wt. The alkali hydroxide may be sodium hydroxide or potassium hydroxide. The alkali carbonate may be sodium carbonate, sodium bicarbonate, potassium carbonate, potassium bicarbonate, or combinations thereof.

The disclosed compositions may further comprise water, preferably soft water. Soft water comprises less than 17 ppm of calcium and magnesium. The disclosed compositions preferably comprise between approximately 80% wt to approximately 95% wt, more preferably between approximately 80% wt to approximately 85% wt or, alternatively, between approximately 85% wt to approximately 95% wt water. As a result, the disclosed compositions are liquid. The pH of the disclosed compositions measured neat at 20° C. ranges from approximately 2 to approximately 4, preferably from approximately 2.5 to approximately 3.

The compositions disclosed above comprise all the ingredients necessary for germ kill and may serve as a biocide and sanitizer. These compositions are single-phase liquids at room temperature, preferably clear single-phase liquids.

The disclosed compositions do not include any additional known germ kill actives in order to achieve germ kill. The benzyl-substituted quaternary ammonium compound is the only quat used in the disclosed compositions. In other words, the disclosed compositions do not include any additional quaternary ammonium compounds, such as dialkyl dimethyl ammonium chloride. Multiple quaternary ammonium species may help achieve sanitization and/or provide better breadth of germ kill. As a result, most commercial sanitizers include a blend of two or more quaternary ammonium compounds. As shown in the examples that follow, Applicant has surprisingly discovered that a composition comprising only the benzyl-substituted quaternary ammonium compound may achieve better than or equivalent germ kill to a composition comprising a multi-quat system. Dialkyl dimethyl ammonium chlorides are currently more expensive than benzyl-substituted quaternary ammonium compounds. As a result, the disclosed compositions provide equivalent or better germ kill in a more cost effective manner.

Applicant also believes that using the benzyl-substituted quaternary ammonium compound as the only quat in acidic formulations provides an improved safety profile as compared to products containing two or more quaternary ammonium compounds in solutions. In vitro assays in accordance with OECD 437 were performed on multiple different compositions with various levels of quaternary ammonium compounds. Applicant was surprised to find that no eye corrosivity was observed during this testing. Based on these results, packaging for the disclosed compositions will not require a child resistant closure. Currently, US in-market sanitizers require child resistant closures due to eye and/or skin corrosivity.

The disclosed compositions do not include any additional known germ kill actives in order to achieve germ kill. As a result, the disclosed compositions are also substantially free of peroxides, such as hydrogen peroxide or peracids. The disclosed compositions are also substantially free of guanides, such as bisguanide. The disclosed compositions are substantially free of alkali metal hypochlorites. While hypochlorites deliver germ kill, they are also known to damage many types of coloured fabrics. The disclosed compositions are substantially free of isocyanurates. The disclosed compositions are also substantially free of borates, such as boric acid or perborates.

The disclosed compositions may also be substantially free of any polyquaternium polymers. As shown in the examples that follow, suitable germ kill is obtained from compositions comprising the benzyl-substituted quaternary ammonium compound alone. However, as will be discussed in more detail infra, addition of some polyquaterniums may also improve germ kill.

To improve aesthetics of the disclosed compositions, a polysaccharide, particularly a cellulose based material, may be added. The polysaccharide or cellulose based material may serve as a thickener. The polysaccharide or cellulose based material may serve as a suspending agent. The polysaccharide or cellulose based material may serve as a softener. The polysaccharide or cellulose based material may be carboxymethyl cellulose, hydroxyethylcellulose, hydropropylmethylcellulose, methylhydroxyethylcellulose, xanthan gum, a fermentation derived cellulose, or combinations thereof. The disclosed compositions comprise between approximately 0.1% wt and approximately 1% wt cellulose based material, preferably between approximately 0.3% wt and approximately 0.8% wt.

Addition of the cellulose based material may transform the disclosed compositions from single phase liquids to a colloidal system. After addition of the cellulose based material, the disclosed compositions have an initial viscosity ranging from approximately 1000 cPs to approximately 2500 cPs as measured on the Brookfield™ DVII+ viscometer equipped with a temperature regulated disposable sample chamber using a SC4-31 spindle after 180 seconds at 12 RPM at 20° C. By adding different types of cellulose, the viscosity at rest as well as the viscosity in motion of the disclosed compositions may be improved (e.g., fermented cellulose materials may help improve viscosity at rest and polysaccharide or cellulose thickeners may improve viscosity in motion).

The viscosity of commercial fabric softeners typically increases with time. Thickening may also occur on exposure to high temperatures or freeze/thaw conditions. Thickened fabric softeners may become unusable for the consumer without the added step of diluting (and reducing effectiveness).

Applicant expects the viscosity of the disclosed compositions to remain close to the initial viscosity or decrease slightly over time. Applicant expects the viscosity of the disclosed composition to remain within approximately 50% to 90% of the initial viscosity over approximately 2 years time, preferably within approximately 65% to 85% of the initial viscosity. As a result, the disclosed compositions may be used in hot climates or subject to freeze/thaw conditions or even just kept on the shelf for longer than traditional fabric softeners without encountering the thickness issues.

The cellulose based material may be hydroxyethylcellulose. One exemplary commercial hydroxyethylcellulose suitable for use in the teachings herein is hydroxyethylcellulose sold by Dow under the tradename Cellosize™ QP100. A 1% wt solution of the cellulose based material in water has a viscosity ranging from approximately 4,400 cPs to approximately 6,000 cPs as measured using a Brookfield viscometer at 25° C. The cellulose based material has a bulk density ranging from approximately 0.3 g/cm³ to approximately 0.6 g/cm³. The hydroxyethylcellulose functions mainly as a thickener.

Another exemplary commercial hydroxyethylcellulose suitable for use in the teachings herein is hydroxyethylcellulose sold by Ashland under the tradename Natrosol™ 250 HHR. This hydroxyethylcellulose is water soluble. As a result, the disclosed compositions remain single phase solutions. As shown in the examples that follow, single phase solutions typically exhibit better stability than emulsions. Many commercially available fabric softeners are emulsions. This hydroxyethylcellulose is also nonionic and unaffected by cations. As a result, this hydroxyethylcellulose does not negatively impact the biocidal efficacy of the benzyl-containing quaternary ammonium compound. This hydroxyethylcellulose functions mainly as a thickener, giving the disclosed composition viscosity.

The cellulose based material may be methylhydroxyethylcellulose. One exemplary commercial methylhydroxyethylcellulose suitable for use in the teachings herein is the methylhydroxyethylcellulose sold by Dow under the tradename SupraCare™ 780. A 1% wt solution of the cellulose based material in water has a viscosity ranging from approximately 12,000 cPs to approximately 16,000 cPs as measured using a Haake Roto Visco RV 100 with a shear rate of 2.55 S⁻¹ at 20° C. A 1% wt solution of the cellulose based material in water has a pH ranging from approximately 6 to approximately 7 at 20° C. The methylhydroxyethylcellulose functions mainly as a thickener.

The cellulose based material may be a fermentation derived cellulose. Fermentation derived cellulose is beneficial because the material does not contain microplastic found in other thickeners, such as styrene-containing and/or polyacrylate polymers. Microplastics contain repeating units that do not break down over time. As a result, microplastics may be bad for the environment, ending up in the food chain and causing further problems, such as endocrine or reproductive system disruptions. In the Fast Moving Consumer Good space, there is a growing trend to avoid formulations containing microplastics to avoid these potential concerns. The disclosed compositions may be substantially free of microplastic materials. One exemplary commercial fermentation derived cellulose suitable for use in the teachings herein is a fermentation derived cellulose sold by CP Kelco under the tradename Cellulon™ RC-76. Another exemplary commercial fermentation derived cellulose suitable for use in the teachings herein is the fermentation derived cellulose sold by CP Kelco under the tradename Cellulon™ R93. The fermentation derived celluloses are particularly useful for suspending materials, such as encapsulated fragrances or opacifiers that are frequently included in laundry formulations. The fermentation derived celluloses may be used as both the thickening and suspending agent. Alternatively, the disclosed compositions may comprise approximately 0.75% wt to approximately 1.25% wt of the fermentation derived cellulose acting as a suspending agent combined with approximately 0.45% wt to approximately 0.75% wt of a hydroxyethylcellulose thickening agent.

The cellulose based material may be a blend of hydropropylmethylcellulose, xanthan gum, and cetyl-hydroxy ethyl cellulose. This blend is commercially available from Ashland under the tradename Ecothix™. This blend also provides a softening benefit to fabrics. This blend may be used alone as both a thickening and softness agent. Alternatively, a low concentration of this blend may be used as a softener with another cellulose serving as the thickener. For example, the disclosed compositions may comprise approximately 0.05% wt to approximately 0.25% wt of this blend with approximately 0.45% wt to approximately 0.75% wt of a methylhydroxyethylcellulose thickening agent.

To improve functionality of the disclosed compositions, a fabric softener, conditioner, and/or protector may be added. The disclosed compositions may comprise approximately 0.05% wt to approximately 1% wt, preferably from approximately 0.05% wt to approximately 0.2% wt, of this material.

As disclosed above, the fermentation derived cellulose and/or polysaccharide blend of hydropropylmethylcellulose, xanthan gum, and cetyl-hydroxy ethyl cellulose may serve as a fabric softener, conditioner, and/or protector.

Alternatively, the fabric softener, conditioner, and/or protector may be stearyldimonium hydropropyl hydrolyzed wheat protein. One exemplary commercial stearyldimonium hydropropyl hydrolyzed wheat protein suitable for use in the teachings herein is the stearyldimonium hydropropyl hydrolyzed wheat protein sold by Croda under the tradename Coltide™ HQS.

In another alternative, the fabric softener, conditioner, and/or protector may be a copolymer of hydrolysed wheat protein and silicone. Two exemplary commercial copolymers suitable for use in the teachings herein are the hydrolysed wheat protein and silicone sold by Croda under the tradename Coltide™ HSi or Coltide™ Radiance. Coltide™ Radiance also provides color protection to, and reduces pilling of, the fabric being treated. Coltide™ Radiance also lubricates the fibers and provides shape protection to the fabric, helping clothing retain its original shape after washing. Coltide™ Radiance is typically used in a detergent during the wash cycle of the automatic laundry process. Applicant believes improved benefits will be obtained by moving use of this material to the rinse cycle.

In another alternative, the fabric softener, conditioner, and/or protector may be a liquid ethoxyquat, particularly a non-polymeric alkoxy quaternary ammonium salt. The liquid non-polymeric quaternary ammonium salt may be N,N′-di(alkylcarboxyethyl)-N-hydroxyethyl-N-methylammonium sulfate. One exemplary commercial source of N,N′-di(alkylcarboxyethyl)-N-hydroxyethyl-N-methylammonium sulfate is Rewoquat™ WE 45 (75% in ethanol) from Evonik. This water soluble ethoxyquat permits formulation of single-phase liquids at room temperature, preferably clear single-phase liquids. Applicant believes that this softener may chemically bind with the fabric, rather than forming a coating on the fabric. This mechanism leaves clothes feeling soft without having a greasy residue, even after multiple washes. This mechanism may also permit the use of a lower concentration of fabric softener than is traditionally used, while maintaining or even exceeding softness feel.

In another alternative, the disclosed compositions are substantially free of any ethoxyquats.

The disclosed compositions further comprise fragrance. The disclosed compositions comprise approximately 0.1% wt to approximately 4% wt, preferably approximately 0.2% wt to approximately 3% wt, more preferably approximately 0.3% wt to approximately 2% wt. One of ordinary skill in the art will recognize that the aroma chemicals in most fragrances are stable at neutral pHs and less stable at the acidic and basic pH extremes. As a result, there are fewer aroma chemicals that remain stable at the acidic pH of the disclosed compositions, producing additional complications.

The fragrance may further comprise malodor control technology, such as receptor blocking and/or chemical binding technologies. Receptor blocking technology blocks the smell of malodor by test subjects, i.e., humans. Chemical binders may chemically bind a better smelling chemical to the malodor chemical. Alternatively, the chemical binder may make the malodor chemical heavy to prevent its volatilization in the air. Exemplary malodor control chemicals include but are not limited to soyaethyl morpholinium ethosulfate; dipropylene glycol; alkanolamine; 7-methyloctyl acetate; 3a,4,5,6,7,7a-hexahydro-4,7-methano-1H-indenyl acetate; 1-(5,5-dimethyl-1-cyclohexen-1-yl)-4-penten-1-one; 2,2,7,7-tetramethyltricyclo[6.2.1.0 (1,6)]undec-4-en-3-one; 3-methyl-5-phenylpentan-1-ol; and any combinations thereof.

The fragrance may further comprise a pro-fragrance. Applicant has defined a pro-fragrance as a perfume compound which is able to release one or more aroma chemicals when triggered by an external influence. Release of the aroma chemical prolongs the perfuming effect. The release may be triggered by exposure to light, air, oxygen, heat, moisture, an enzyme, or any combination thereof. Exemplary pro-fragrance perfume compounds include but are not limited to 3-(dodecylthio)-1-(2,6,6-trimethylcyclohex-3-en-1-yl) butan-1-one sold by Firmenich under the trade name HaloScent™ D, 4-(dodecylthio)-4-(2,6,6-trimethylcyclohex-2-en-1-yl) butan-2-one sold by Firmenich under the trade name HaloScent™ I, 4-(dodecylthio)-4-(2,6,6-trimethylcyclohex-1-en-1-yl) butan-2-one sold by Firmenich under the trade name HaloScent™ I, ethyl N, S-bis(4-oxo-4-(2,6,6-trimethylcyclohex-3-en-1-yl) butan-2-yl) cysteinate sold by Givaudan under the tradename Scentaurus™ Berry, ethyl (Z)-2-acetyl-4-methyltridec-2-enoate sold by Givaudan under the tradename Scentaurus™ Clean, 4-(dodecylthio)-4-methylpentan-2-one sold by Givaudan under the tradename Scentaurus™ Juicy, or any combination thereof.

The disclosed compositions may further comprise an encapsulated fragrance. The encapsulated fragrances are suspended in the disclosed compositions. Encapsulated fragrances provide long term fragrance benefits to fabrics. The encapsulated fragrance is captured in the fabric during the rinse process and releases the fragrance when the encapsulate degrades with time or bursts from pressure. Many classical encapsulated fragrances utilized shells that release formaldehyde. Exposure to formaldehyde may cause adverse health effects. Therefore, the disclosed compositions are substantially free of any encapsulated fragrances that release formaldehyde. Preferably, the fragrance is encapsulated by a polyacrylate or biodegradable shell.

Applicant believes that the disclosed compositions provide improved deposition of encapsulated fragrances having polyacrylate shells or any other shells having a negative charge. Applicant theorizes that positively charged benzyl-substituted quaternary and/or benzyl-substituted polyquaternium compound binds to both the negative charge of the polyacrylate shell and to fiber sites on the clothing, leading to improved fragrance deposition. The combination of the encapsulated fragrance with the long lasting or profragrance free oil technology is theorized to lead to better long-term performance by providing technologies that evaporate slowly and/or provide quick bursts of freshness in the presence of friction, leading to a longer perceived fragrance experience.

Exemplary encapsulated fragrances suitable for use in the disclosed compositions may be formed from the reaction product of at least one multifunctional alpha, beta-unsaturated carbonyl compound with a nanocellulose or microcrystalline cellulose. The alpha, beta-unsaturated carbonyl compound may be a multifunctional methacrylate, such as glycerol dimethacrylate, ethylene glycol dimethacrylate, butylene glycol dimethacrylate, propylene glycol dimethacrylate, bisphenol A dimethacrylate, and mixtures thereof. More details may be found in PCT Published Patent App No WO2022/249052 to Takasago Int'l Corp, the details of which are incorporated in its entirety herein by reference.

Alternatively, exemplary encapsulated fragrances suitable for use in the disclosed compositions may be formed by reacting a polyfunctional monomer with a reactant in the presence of a plant-based protein. For example, acyl chloride may be reacted with one or more amino compounds in the presence of a potato protein or chickpea protein. Exemplary amino compounds include ethylene diamine, diethylene triamine, L-lysine, or combinations thereof. More details may be found in PCT Published Patent App No WO2023/057262 to Firmenich SA, the details of which are incorporated in its entirety herein by reference.

One of ordinary skill in the art will recognize that dispersion of both the benzyl-substituted quaternary ammonium compound and the encapsulated fragrance in an acidic aqueous carrier provides potential stability issues. More specifically, the formulation may separate. The disclosed compositions solve these stability issues.

When the disclosed compositions comprise encapsulated fragrances, the resulting composition may be opaque. As a result, the disclosed compositions may be substantially free of any opacifiers. Alternatively, the disclosed compositions may further comprise an opacifier. Opacifiers are added purely for aesthetic reasons to give the appearance of “traditional” fabric conditioners. The disclosed compositions may comprise between approximately 0.1% wt to approximately 0.5% wt opacifier. An exemplary opacifier may be a blend of cocamidopropyl betaine and glycol distearate. This exemplary opacifier is commercially available from Solvay under the tradename Miracare™ OPR2, previously known as Mackadet™ OPR2. Alternatively, the opacifier may be a blend of ethylene distearate and hydroxyethyl stearate sold under the tradename Dapracare™ OPC-1 by Italmatch Chemicals S.p.A. In another alternative, the opacifier may be a blend of ethylene distearate and a nonionic surfactant sold under the tradename Dapracare™ OPC-3 by Italmatch Chemicals S.p.A. In yet another alternative, the opacifier may be PEG-2 stearate sold under the tradename Cithrol™ DEGMS by Croda.

The disclosed compositions may optionally comprise a non-ionic surfactant, preferably an alkylamine oxide. The alkylamine oxide may be a C10-C14 alkylamine oxide, preferably lauramine oxide. The composition may comprise approximately 0.3% wt to approximately 1.5% wt alkylamine oxide, preferably between approximately 0.4% wt to approximately 1% wt. The composition may comprise approximately 0.3% wt to approximately 1.5% wt C10-C14 alkylamine oxide, preferably between approximately 0.4% wt to approximately 1% wt. The composition may comprise approximately 0.3% wt to approximately 1.5% wt lauramine oxide, preferably between approximately 0.4% wt to approximately 1% wt. The composition may comprise approximately 0.3% wt to approximately 1.5% wt decyl amine oxide, preferably between approximately 0.4% wt to approximately 1% wt. As shown in the examples that follow, the alkylamine oxide enhances the antimicrobial efficacy of the benzyl-substituted quaternary ammonium compound.

Alternatively, the disclosed compositions may be substantially free of non-ionic surfactants. Specially, the disclosed compositions may be substantially free of betaine surfactants. The disclosed compositions may also be substantially free of unsaturated fatty alcohols.

The disclosed compositions are substantially free of anionic surfactants, such as alkyl sulfates and alkyl ether sulfates. Anionic surfactants tend to introduce foaming, which is not desired in the final rinse stage of a laundry process.

The disclosed compositions may further comprise enzymes for additional benefits. Cellulase keeps clothes looking new longer. Phosphodiesterase helps remove body stains from clothes. Amylase and protease help remove generic stains from clothes, including enzymatic stains left behind by detergents. Amylase and/or protease also help remove food for bacteria, which may lead to bad smells.

Alternatively, the disclosed compositions may be substantially free of enzymes, particularly when additional benefits are not needed.

The disclosed compositions may optionally comprise phenoxyethanol. The composition may comprise approximately 0.4% wt to approximately 1% wt phenoxyethanol, preferably between approximately 0.4% wt to approximately 0.6% wt.

The disclosed compositions may be substantially free of alkanolamine, such as monoethanolamine, diethanolamine, triethanolamine, or combinations thereof.

In addition to water, the disclosed composition may optionally further comprise a carrier solvent. Exemplary carrier solvents include methanediol, 1,2-propanediol, 1,3-propanediol, 1,2-butanediol, 1,3-butanediol, 1,4-butanediol, 2,3-butanediol, polyethyelene glycol, polypropylene glycol, glycerin, water, or combinations thereof. Preferably carrier solvents include 1,2-propanediol, 1,3-propanediol, glycerin, water, and combinations thereof. The disclosed compositions comprise between approximately 0.1% wt to approximately 2.5% wt of non-aqueous carrier solvent, preferably between approximately 0.25% wt to approximately 2% wt of a non-aqueous carrier solvent. One of ordinary skill in the art will recognize that many raw materials are supplied in non-aqueous carrier solvents. As a result, the disclosed composition may comprise between approximately 0.25% wt to approximately 1% wt of added non-aqueous carrier solvent, such as propylene glycol (i.e., 1,2-propanediol), preferably between approximately 0.3% wt to approximately 0.75% wt. The non-aqueous solvent may enhance stability of the disclosed compositions at low temperatures.

Alternatively, the disclosed compositions may be substantially free of non-aqueous solvents, such as glycol ethers. The disclosed compositions may also be substantially free of added alcohols, such as ethanol. One of ordinary skill in the art will recognize that the benzyl-substituted quaternary ammonium compounds are frequently supplied in an alcohol or glycol solvent. However, more of these solvents are not deliberately added to the disclosed compositions.

The disclosed compositions may be substantially free of an added electrolyte, such as sodium chloride.

Exemplary laundry compositions comprise approximately 2% wt to approximately 4% wt of a benzyl-substituted quaternary ammonium compound and three or more pH adjusters, the pH adjusters being selected from the group consisting of citric acid, sodium citrate, an alkali hydroxide, and combinations thereof.

For example, the exemplary laundry compositions comprise:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Water | q.s. | q.s. |

As shown in the examples that follow, when used during the last rinse cycle of a laundry washing process, these laundry compositions obtain a 5 log 10 reduction in Staphylococcus aureus, Enterococcus hirae, Escherichia coli, and Pseudomonas aeruginosa a 4 log 10 reduction in Candida albicans. This means the above composition qualifies as a laundry disinfectant composition under European regulations.

The laundry compositions may further comprise a softener, which provides softness effect to the fabric, for example to cotton fibers. The exemplary laundry compositions may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Polysaccharide-derived softener | ~0.005 to ~1.5 | ~0.01 to ~1 |
| Water | q.s. | q.s. |

Alternatively, the exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Hydrolyzed protein copolymer | ~0.005 to ~3 | ~0.01 to ~1 |
| softener | | |
| Water | q.s. | q.s. |

The laundry compositions may further comprise an enzyme, which may impart additional benefits to clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Enzyme | ~0.1 to ~4 | ~0.25 to ~1.5 |
| Water | q.s. | q.s. |

The laundry compositions may further comprise a cellulase enzyme, which may help keep clothes treated with the disclosed compositions looking new for longer. For example, these exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulase (e.g., Celluclean ™ or | ~0.1 to ~1 | ~0.1 to ~0.75 |
| Carezyme Essential from | | |
| Novozymes) | | |
| Water | q.s. | q.s. |

The laundry compositions may further comprise a phosphodiesterase enzyme, which help remove body stains from clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Phospodiesterase (e.g., Pristine ™ | ~0.1 to ~4 | ~0.5 to ~2 |
| 100 L from Novozymes) | | |
| Water | q.s. | q.s. |

The laundry compositions may further comprise an amylase and/or protease enzyme, which may help remove generic stains from clothes treated with the disclosed compositions, including enzymatic stains left behind by detergents. These enzymes help remove food for bacteria, which may cause bad smells. For example, these exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Protease (e.g., Progress Uno from | ~0.1 to ~4 | ~0.25 to ~0.75 |
| Novozymes) | | |
| Water | q.s. | q.s. |

For aesthetic reasons, the laundry compositions may further comprise thickeners, fragrances, and/or dyes. For example, these exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and other aesthetic parameters may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Enzyme | ~0.1 to ~4 | ~0.25 to ~1.5 |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and help keep clothes looking new for longer may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Cellulase (e.g., Celluclean ™ or | ~0.1 to ~1 | ~0.1 to ~0.75 |
| Carezyme Essential from | | |
| Novozymes) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and help remove body stains from clothes treated with the disclosed compositions may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Phospodiesterase (e.g., Pristine ™ | ~0.1 to ~4 | ~0.5 to ~2 |
| 100 L from Novozymes) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and help remove generic stains from clothes treated with the disclosed compositions, including enzymatic stains left behind by detergents, may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Protease (e.g., Progress Uno from | ~0.1 to ~4 | ~0.25 to ~0.75 |
| Novozymes) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill, softness, and other aesthetic parameters may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Hydrolyzed protein copolymer | ~0.05 to ~2 | ~0.1 to ~1 |
| softener (e.g., Coltide ™ HSi, HQS, | | |
| or Radiance) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Fragrance | 0 to ~4 | ~0.3 to ~2 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Polysaccharide-derived softener | ~0.05 to ~2 | ~0.1 to ~1 |
| (e.g., Ecothix ™) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Fragrance | 0 to ~4 | ~0.3 to ~2 |
| Water | q.s. | q.s. |

Inclusion of encapsulated fragrances in the laundry compositions helps fabrics remain fresh long after washing. For example, these exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Encapsulated fragrance, preferably | ~0.05 to ~1.5 | ~0.1 to ~1 |
| having a polyacrylate or | | |
| biodegradable shell (i.e., not | | |
| formaldehyde-releasing shells) | | |
| Non-encapsulated fragrance | 0 to ~4 | ~0.3 to ~2 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Polysaccharide-derived softener | ~0.05 to ~2 | ~0.1 to ~1 |
| (e.g., Ecothix ™) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Encapsulated fragrance, preferably | ~0.05 to ~1.5 | ~0.1 to ~1 |
| having a polyacrylate or | | |
| biodegradable shell (i.e., not | | |
| formaldehyde-releasing shells) | | |
| Dye | 0 to ~0.002 | ~0.0008 to ~0.0018 |
| Non-encapsulated fragrance | 0 to ~4 | ~0.3 to ~2 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Hydrolyzed protein copolymer | ~0.05 to ~2 | ~0.1 to ~1 |
| softener (e.g., Coltide ™ HSi, HQS, | | |
| or Radiance) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Encapsulated fragrance, preferably | ~0.05 to ~1.5 | ~0.1 to ~1 |
| having a polyacrylate or | | |
| biodegradable shell (i.e., not | | |
| formaldehyde-releasing shells) | | |
| Dye | 0 to ~0.002 | ~0.0008 to ~0.0018 |
| Non-encapsulated fragrance | 0 to ~4 | ~0.3 to ~2 |
| Water | q.s. | q.s. |

One exemplary method of making the disclosed compositions is provided in Example 1. One of ordinary skill in the art will recognize that each cellulose material may have different hydration procedures and should follow the manufacturing recommendations provided by the cellulose supplier in order to avoid having “fish-eye” clumps in the final compositions.

As shown in the examples that follow, the concentration of benzyl-substituted quaternary ammonium compounds may be reduced when specific polymers are added to the composition and still provide equivalent germ kill to compositions containing higher concentrations of the benzyl-substituted quaternary ammonium compounds. Benzyl-substituted quaternary ammonium compounds are known to be toxic to aquatic environments. The ability to reduce the concentration of the benzyl-substituted quaternary ammonium compound is therefore beneficial. Additionally, the composition does not require a large percentage of these polymers, which helps contain formulations costs. The polymer may be selected from the group consisting of poly(diallyldimethylammonium chloride) (PQ6) having a molecular weight <100 kDa (PQ6<100 kDa); PQ6 having a molecular weight ranging from 200 kDa to 300 kDa (PQ6 200-300 kDa); PQ6 having a molecular weight ranging from 400 kDa to 500 kDa (PQ6 400-500 kDa); copolymers of vinylpyrrolidone (VP) and quaternized vinylimidazole (QVI) (PQ16) having 5% wt VP and 95% wt QVI (PQ16 5VP-95QVI); PQ16 having 50% wt VP and 95% wt QVI (PQ16 50VP-50QVI); Poly(2-dimethylamino)ethyl methacrylate) methyl chloride quaternary salt (PQ37); 1-propanaminium, N,N,N-trimethyl-3-[(1-oxo-2-propenyl)amino] chloride, homopolymer (A1000); 1-dodecanaminium, N, N-dimethyl-N-[3-[(2-methyl-1-oxo-2-propen-1-yl)amino]propyl]-, chloride (1:1), polymer with sodium 2-methyl-2-[(1-oxo-2-propen-1-yl)amino]-1-propanesulfonate (1:1) and N, N, N-trimethyl-3-[(1-oxo-2-propen-1-yl)amino]-L propanaminium chloride (1:1) (C113); and combinations thereof.

Exemplary laundry compositions comprise approximately 1.25% wt to approximately 3.3% wt of a benzyl-substituted quaternary ammonium compound, approximately 0.25% wt to approximately 4% of a first polyquaternium compound, and three or more pH adjusters, the pH adjusters being selected from the group consisting of citric acid, sodium citrate, an alkali hydroxide, and combinations thereof. For example, the exemplary laundry compositions comprise:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Water | q.s. | q.s. |

When used during the last rinse cycle of a laundry washing process, Applicant believes that these laundry compositions will obtain a 5 log 10 reduction in Staphylococcus aureus, Enterococcus hirae, Escherichia coli, and Pseudomonas aeruginosa a 4 log 10 reduction in Candida albicans. This means the above composition will qualify as a laundry disinfectant composition under European regulations.

The laundry compositions may further comprise a softener, which provides softness effect to the fabric, for example to cotton fibers. The exemplary laundry compositions may comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Polysaccharide-derived softener | ~0.005 to ~1.5 | ~0.01 to ~1 |
| Water | q.s. | q.s. |

Alternatively, the exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Hydrolyzed protein copolymer | ~0.005 to ~3 | ~0.01 to ~1 |
| softener | | |
| Water | q.s. | q.s. |

The laundry compositions may further comprise an enzyme, which may impart additional benefits to clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Enzyme | ~0.1 to ~4 | ~0.25 to ~1.5 |
| Water | q.s. | q.s. |

The laundry compositions may further comprise a cellulase enzyme, which may help keep clothes treated with the disclosed compositions looking new for longer. For example, these exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulase (e.g., Celluclean ™ or | ~0.1 to ~1 | ~0.1 to ~0.75 |
| Carezyme Essential from | | |
| Novozymes) | | |
| Water | q.s. | q.s. |

The laundry compositions may further comprise a phosphodiesterase enzyme, which help remove body stains from clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Phospodiesterase (e.g., Pristine ™ | ~0.1 to ~4 | ~0.5 to ~2 |
| 100 L from Novozymes) | | |
| Water | q.s. | q.s. |

The laundry compositions may further comprise an amylase and/or protease enzyme, which may help remove generic stains from clothes treated with the disclosed compositions, including enzymatic stains left behind by detergents. For example, these exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Protease (e.g., Progress Uno from | ~0.1 to ~4 | ~0.25 to ~0.75 |
| Novozymes) | | |
| Water | q.s. | q.s. |

For aesthetic reasons, the laundry compositions may further comprise thickeners, fragrances, and/or dyes. For example, these exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill, softness, and other aesthetic parameters may comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Hydrolyzed protein copolymer | ~0.05 to ~2 | ~0.1 to ~1 |
| softener (e.g., Coltide ™ HSi, HQS, | | |
| or Radiance) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Fragrance | 0 to ~4 | ~0.3 to ~2 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Polysaccharide-derived softener | ~0.05 to ~2 | ~0.1 to ~1 |
| (e.g., Ecothix ™) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and other aesthetic parameters may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Enzyme | ~0.1 to ~4 | ~0.25 to ~1.5 |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and help keep clothes looking new for longer may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Cellulase (e.g., Celluclean ™ or | ~0.1 to ~1 | ~0.1 to ~0.75 |
| Carezyme Essential from | | |
| Novozymes) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and help remove body stains from clothes treated with the disclosed compositions may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Phospodiesterase (e.g., Pristine ™ | ~0.1 to ~4 | ~0.5 to ~2 |
| 100 L from Novozymes) | | |
| Dye | 0 to ~0.002 | ~0.0008 to ~0.0018 |
| Fragrance | 0 to ~4 | ~0.3 to ~2 |
| Water | q.s. | q.s. |

Compositions that meet germ kill and help remove generic stains from clothes treated with the disclosed compositions, including enzymatic stains left behind by detergents, may comprise, consist essentially of, or consist of:

| Ingredient | % wt | Preferable % wt |
|---|---|---|
| Benzyl-substituted quaternary | ~2 to ~4 | ~2.25 to ~2.75 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Protease (e.g., Progress Uno from | ~0.1 to ~4 | ~0.25 to ~0.75 |
| Novozymes) | | |
| Dye | 0 to ~0.002 | ~0.0008 to ~0.0018 |
| Fragrance | 0 to ~4 | ~0.3 to ~2 |
| Water | q.s. | q.s. |

Inclusion of encapsulated fragrances in the laundry compositions helps fabrics remain fresh long after washing. For example, these exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Cellulose based thickener, such as | ~0.1 to ~2 | ~0.2 to ~1.8 |
| Methylhydroxyethylcellulose | | |
| (e.g., Supracare ™ 780) or | | |
| Hydroxypropylmethylcellulose | | |
| (e.g., Cellosize ™ QP100) | | |
| Dye | 0 to ~0.002 | ~0.0008 to ~0.0018 |
| Encapsulated fragrance, preferably | ~0.05 to ~1.5 | ~0.1 to ~1 |
| having a polyacrylate or | | |
| biodegradable shell (i.e., not | | |
| formaldehyde-releasing shells) | | |
| Non-encapsulated fragrance | 0 to ~4 | ~0.3 to ~2 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Polysaccharide-derived softener | ~0.05 to ~2 | ~0.1 to ~1 |
| (e.g., Ecothix ™) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Encapsulated fragrance, preferably | ~0.05 to ~1.5 | ~0.1 to ~1 |
| having a polyacrylate or | | |
| biodegradable shell (i.e., not | | |
| formaldehyde-releasing shells) | | |
| Dye | 0 to ~0.002 | ~0.0008 to ~0.0018 |
| Non-encapsulated fragrance | 0 to ~4 | ~0.3 to ~2 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~1.25 to ~3.3 | ~1.5 to ~3 |
| ammonium compound (e.g., C12-18 | | |
| or C12-C16 alkyl dimethyl benzyl | | |
| ammonium chloride) | | |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Citric acid | ~4 to ~6 | ~4.5 to ~5.5 |
| Sodium citrate | ~0.8 to ~2 | ~1 to ~1.5 |
| Sodium Hydroxide | ~0.005 to ~0.03 | ~0.005 to ~0.02 |
| Hydrolyzed protein copolymer | ~0.05 to ~2 | ~0.1 to ~1 |
| softener (e.g., Coltide ™ HSi, HQS, | | |
| or Radiance) | | |
| Cellulose based thickener, such as | ~0.25 to ~1 | ~0.25 to ~0.7 |
| Methylhydroxyethylcellulose | | |
| (e.g., Supracare ™ 780) or | | |
| Hydroxypropylmethylcellulose | | |
| (e.g., Cellosize ™ QP100) | | |
| Encapsulated fragrance, preferably | ~0.05 to ~1.5 | ~0.1 to ~1 |
| having a polyacrylate or | | |
| biodegradable shell (i.e., not | | |
| formaldehyde-releasing shells) | | |
| Dye | 0 to ~0.002 | ~0.0008 to ~0.0018 |
| Non-encapsulated fragrance | 0 to ~4 | ~0.3 to ~2 |
| Water | q.s. | q.s. |

Liquid laundry products are also disclosed. The liquid laundry products comprise a container comprising any of the liquid laundry compositions disclosed above. Any container suitable for holding liquids may be used. The disclosed liquid laundry compositions may not trigger the requirement for child-resistant packaging under 40 C.F.R. § 157, subpart B. Applicant also expects the formulation to comply with similar European regulations. As a result, the container may not require a child-resistant cap. Child-resistant packaging is required if the formulation:
has an acute oral lethal dose of 1.5 g/kg or less;
has an acute dermal lethal dose of 2,000 mg/kg or less;
has acute inhalation of lethal concentration of 2 mg/L or less;
is corrosive to the eye (causing irreversible destruction of ocular tissue) or causes corneal involvement or irritation persisting for 21 days or more;
is corrosive to the skin (causing tissue destruction into the dermis and/or scarring) or causes severe skin irritation (severe erythema or edema) at 72 hours;
has such characteristics that, based upon human toxicological data, use history, accident data, or such other evidence as available, the EPA determines there is serious hazard of accidental injury or illness which child-resistant packaging could reduce.

Methods of sanitizing laundry during a laundry washing process using any of the disclosed compositions are also disclosed. The disclosed methods may further soften and/or treat the fabrics being laundered. Exemplary fabrics include but are not limited to cotton, spandex, microfiber, polyester, rayon, nylon, lycra, or any combination thereof. About 60 mL to about 180 mL, preferably about 120 mL to about 150 mL, of the disclosed compositions is added to the fabric softener compartment of an automatic washing machine. The disclosed compositions are used in the last rinse cycle of the automatic washing machine process. Approximately 120 mL to approximately 180 mL is added to the fabric softener compartment of a top loading washing machine that uses approximately 47 L per rinse. Approximately 30 mL to approximately 120 mL is added to the fabric softener compartment of a front loading washing machine that uses approximately 17 L per rinse.

At least a 1:159 dilution, preferably a 1:175 dilution, of the disclosed compositions with water achieves at least a 5 logo reduction according to the EN1276 protocol, under clean conditions in no more than 22 minutes at 20° C.

A 1:84 of the disclosed compositions with water achieves at least a 3 log 10 reduction according to the EN17658 protocol, under clean conditions in no more than 22 minutes at 20° C.

### EXAMPLES

The following examples illustrate exemplary compositions as well as preferred embodiments of the invention. It is to be understood that these examples are provided by way of illustration only and that further useful compositions falling within the scope of the present invention and the claims may be readily produced by one skilled in the art without deviating from the scope and spirit of the invention.

The compositions in the following examples were prepared using the materials identified in Table A:

TABLE A

| Abbr | CAS | Description |
|---|---|---|
| BKC | 68391- | C12-18 alkyldimethylbenzylammonium chloride, e.g., BTC ™ 1218 |
| | 01-5 | (80% in ethanol and water) sold by Stepan |
| DDAC | 68424- | Blend of dioctyldimethylammonium chloride, |
| | 95-3 | octyldecyldimethylammonium chloride, & |
| | | didecyldimethylammonium chloride, e.g., BARDAC ™ 2080 (80% |
| | | in ethanol and water) sold by Arxada |
| CA | 77-92-9 | Citric Acid Anhydrous |
| NaOH | 1310-73- | Sodium Hydroxide (50% in water) |
| | 2 | |
| TNC | 6132-04- | Trisodium citrate dihydrate |
| | 3 or 68- | |
| | 04-2 | |
| H2O | 7732-18- | Water |
| | 5 | |
| HPMC | 9004-62- | Hydroxypropylmethylcellulose (HPMC), e.g., Cellosize ™ QP100 |
| | 0 | sold by Dow |
| MHEC | 9032-42- | Methylhydroxyethylcellulose, e.g., Supracare ™ 780 sold by Dow |
| | 2 | |
| HEC | 9004-62- | 2-Hydroxyethyl ether cellulose, e.g., Cellulon RC-76 sold by CP |
| | 0 | Kelco or Natrosol ™ 250 HHR sold by Ashland (>94% sodium |
| | | sulfate) |
| HQS | | Stearyldimonium hydroxypropyl hydrolysed wheat protein, e.g., |
| | | Coltide ™ HQS sold by Croda |
| ET | | Polysaccharide blend of hydropropylmethylcellulose, xanthan |
| | | gum, and cetyl-hydroxy ethyl cellulose, e.g., Ecothix ™ sold by |
| | | Ashland |
| D | Various | Various Dyes |
| F | Various | Various Fragrances |
| Encap | Various | Various encapsulated fragrances dispersed in a slurry, preferably |
| | | having a polyacrylate or biodegradable shell (i.e., not |
| | | formaldehyde-releasing shells) |
| 9EO | 68551- | Ethoxylated C12-16 Alcohols e.g., Genapol ™ LA 090 sold by |
| | 12-2 | Clariant |
| SLES | 68585- | Sodium lauryl ether sulfate e.g., Calfoam ™ ES-302 (27% active) |
| | 34-2 | sold by Pilot |
| CocoB | 61789- | Cocoamidopropyl Betaine e.g., Galaxy ™ CAPB SB (30% in water) |
| | 40-0 | sold by Tri-K Industries |
| APG | 110615- | Lauryl glucoside, e.g., Glucopon ™ 425n (50% in water) sold by |
| | 47-9 | BASF |
| LO | 1643-20- | Lauramine oxide, e.g., Ammonyx ™ LO (30% in water) sold by |
| | 5 | Stepan |
| PQ6 | 26062- | Poly(diallyldimethylammonium chloride) e.g., poly(DADMAC) |
| | 79-3 | <100 kDa (35% in water) or 200-300k or 400-500k (both 20% in |
| | | water), all sold by Sigma Aldrich |
| PQ7 | 26590- | Poly(acrylamide-co-diallyldimethylammonium chloride), e.g., 10% |
| | 05-6 | solution sold by Sigma Aldrich |
| PQ16 | 95144- | Copolymers of vinylpyrrolidone (VP) and quaternized |
| | 24-4 | vinylimidazole (QVI) (5VP-95QVI), e.g., Luviquat ™ Excellence |
| | | (38.42% in water) sold by BASF |
| PQ16 | 95144- | Copolymers of VP and QVI (50VP-50QVI), e.g., Luviquat ™ FC550 |
| | 24-4 | (38% in water) sold by BASF |
| PQ16 | 95144- | Copolymers of VP and QVI (70VP-30QVI), e.g., Luviquat ™ (38% |
| | 24-4 | in water) sold by BASF |
| A1000 | 26427- | 1-propanaminium, N,N,N-trimethyl-3-[(1-oxo-2-propenyl)amino] |
| | 01-0 | chloride, homopolymer, e.g., N-Durhance A1000 (15-25% in |
| | | water) sold by Ashland |
| PQ28 | 131954- | 2-pyrrolidinone, 1-ethenyl-, polymer with N, N, N-trimethyl-3-[(2- |
| | 48-8 | methyl-1-oxo-2-propenyl)amino]-1-propanaminium chloride, e.g., |
| | | Gafquat ™ HS-100 (15-25% in water) sold by Ashland |
| PQ37 | 26161- | Poly(2-dimethylamino)ethyl methacrylate) methyl chloride |
| | 33-1 | quaternary salt, e.g., MADQUAT (100% powder) sold by Sigma |
| | | Aldrich |
| C113 | 26427- | 1-dodecanaminium, N,N-dimethyl-N-[3-[(2-methyl-1-oxo-2- |
| | 33-1 | propen-1-yl)amino]propyl]-, chloride (1:1), polymer with sodium 2- |
| | | methyl-2-[(1-oxo-2-propen-1-yl)amino]-1-propanesulfonate (1:1) |
| | | and N,N,N-trimethyl-3-[(1-oxo-2-propen-1-yl)amino]-L |
| | | propanaminium chloride (1:1), e.g., Chromohance ™ 113 (15-25% |
| | | in water) sold by Ashland |

### Example 1

The compositions are provided in Table 1:

TABLE 1

| Material | C1 | C2 | C3 | C4 | E1 | E2 | E3 | E4 |
|---|---|---|---|---|---|---|---|---|
| BKC | 7.68 | 6 | 7.68 | 6 | 3.04 | 3.65 | 3.04 | 3.04 |
| (80%) | (6.14) | (4.8) | (6.14) | (4.8) | (2.43) | (2.92) | (2.43) | (2.43) |
| CA | 5.2 | 5.2 | 5.2 | 5.2 | 5.2 | 5.2 | 5.2 | 5.2 |
| TNC | 0 | 0 | 1.3 | 1.3 | 1.3 | 1.3 | 1.3 | 1.3 |
| NaOH | 1.017 | 1.017 | 0.017 | 0.017 | 0.017 | 0.017 | 0.017 | 0.017 |
| (50%) | (0.508) | (0.508) | (0.0085) | (0.0085) | (0.0085) | (0.0085) | (0.0085) | (0.0085) |
| HPMC | 0.625 | 0.625 | 0.625 | 0.625 | 0.625 | 0.625 | 0 | 0 |
| HEC | 1 | 1 | 1 | 1 | 1 | 1 | 0 | 0 |
| MHEC | 0 | 0 | 0 | 0 | 0 | 0 | 0.525 | 0.32 |
| HQS | 0 | 0 | 0 | 0 | 0 | 0 | 0.2 | 0 |
| D | 0.08 | 0.08 | 0.08 | 0.08 | 0.08 | 0.08 | 0.0035 | 0.008 |
| F | 1 | 1 | 1 | 1 | 1 | 1 | 1.5 | 1 |
| Encap | 0.2 | 0.2 | 0.2 | 0.2 | 0.2 | 0.2 | 0.4 | 0 |
| H2O | 83.198 | 84.878 | 82.898 | 84.578 | 87.538 | 86.928 | 87.814 | 89.115 |
| Total | 100 | 100 | 100 | 100 | 100 | 100 | 100 | 100 |

The formulations were prepared by adding H2O to a tank with a mixer. The mixer was started. HPMC or MHEC was added and mixed until homogenous. If present in the composition, HEC or HQS was added and mixed until homogenous. The mixture became hazy/opaque after addition of HEC or HQS. After the mixture thickens and becomes transparent, TNC was added and mixed until homogeneous. The viscosity of the mixture increases significantly to approximately 2,200 cPs as measured on the Brookfield™ DVII+ viscometer equipped with a temperature regulated disposable sample chamber using a SC4-31 spindle after 180 seconds at 12 RPM at 20° C. CA was added and mixed until homogeneous. The package containing the BKC raw material was mixed/shaken to ensure uniformity. The recently mixed/shaken BKC raw material is then added to the tank and mixed until homogeneous. If present in the composition, Encap is added to the tank and mixed until homogeneous. F and D were added and mixed until homogeneous. NaOH was added to adjust pH to target and mixed until homogenous. The final composition was a light blue translucent liquid.

Alternatively, the formulations were prepared by adding H2O to the tank with a mixer and starting the mixer. HPMC or MHEC were added and mixed until homogenous. CA was added and mixed until homogeneous. TNC was added and mixed until homogeneous. The package containing the BKC raw material was mixed/shaken to ensure uniformity. The recently mixed/shaken BKC raw material was then added to the tank and mixed until homogeneous. If present in the composition, HEC or HQS was added and mixed until homogenous. The mixture became hazy/opaque after addition of HEC or HQS. If present in the composition, Encap was added to the tank and mixed until homogeneous. F and D were added and mixed until homogeneous. NaOH was added to adjust pH to target and mixed until homogenous. The final composition was a light blue translucent liquid.

No heating is needed for either process, providing for a more cost effective and safe manufacturing process.

In another alternative, the formulations were prepared by adding H2O to the tank with a mixer and starting the mixer. HPMC or MHEC were added and mixed until homogenous. To help achieve homogeneity, the mixing speed may be increased and/or the temperature of the water may be raised from approximately 70° F. (21° C.) to approximately 90° F. (32° C.). Once the HPMC or MHEC is homogeneously mixed in the water, the mixing speed is decreased to add HEC or HQS. No additional optional heating is used after addition of the HPMC or MHEC. After all of the HEC or HQS is added, the mixture is mixed for approximately 10 to approximately 20 minutes. Care must be taken during addition of HEC and/or HQS to make sure no clumping (fish eyes) occurs. NaOH is added next and the resulting mixture is mixed for approximately 45 minutes to approximately 1 hour to ensure uniformity. The NaOH increases the thickness of the formulation and the mixing speed may be increased to compensate. An in-process viscosity sample is obtained and tested. Processing may continue after the sample demonstrates viscosity of 115 cps or higher as measured after 60 seconds at 50 RPM using a LV62 spindle at ambient temperature. Once the viscosity limitation is met, CA was added and mixed until homogeneous. TNC was added and mixed until homogeneous. An in-process sample was taken to measure pH. Once the pH is 4 or less, the container of the optional Encap was shaken to ensure homogeneity and then added and mixed for at least approximately 10 minutes. An in-process sample in a clear jar is taken to ensure that the Encap is uniformly dispersed. Shake the package containing the BKC raw material to ensure uniformity. Add the recently mixed/shaken BKC raw material to the tank and mixed until homogeneous. Add F and mix until homogeneous. Add D and mix until homogeneous.

### Example 2 Antimicrobial Efficacy

The comparative samples C1 through C4 and the exemplary samples E1 through E4 of Example 1 were evaluated for their antimicrobial efficacy against Staphylococcus aureus (ATCC 6538 or DSM 799), Escherichia coli (ATCC 10536), Pseudomonas aeruginosa (ATCC 15442), Enterococcus hirae (ATCC 10541 or DSM 3320), and Candida albicans (ATCC10231) using an antimicrobial suspension test based on British Standard reference No: EN 1276:2019-12 method entitled “Chemical Disinfectants and Antiseptics-Quantitative Suspension Test for the Evaluation of bactericidal activity of chemical disinfectants and antiseptics used in food, industrial, domestic and institutional areas-Test method and requirements (Phase 2, step 1)”. A greater than 5-log 10 reduction of all organisms for a contact time of 1 to 60 minutes (determined by product specification) at a testing temperature ranging from 4° C. to 60° C.±1.0° C. (determined by product specification) is required to pass the EN1276. Additional and optional contact times, temperatures, and test organisms can be used.

The test protocol evaluates the efficacy of the compositions of the present invention and the comparative examples against gram-negative and gram-positive bacteria. The test organisms evaluated were Staphylococcus aureus (ATCC 6538 or DSM 799), Escherichia coli (ATCC 10536), Pseudomonas aeruginosa (ATCC 15442) and Enterococcus hirae (ATCC 10541 or DSM 3320).

The bacterial strains were cultured on tryptic soy agar (TSA) slant from frozen stock and incubated for 18-24 hours. Following incubation, 2^{nd} and 3^{rd} generation transfers were prepared and used to prepare test suspensions as described in the British Standard EN 1276 test method titled Chemical disinfectants and antiseptics. Quantitative suspension test for the evaluation of bactericidal activity of chemical disinfectants and antiseptics used in food, industrial, domestic, and institutional areas. The working culture must be either a second or third generation subculture on TSA slants from a cryogenic stock. The cell suspensions were adjusted to produce approximately 1.5-5.0×10⁸ CFU mL⁻¹. Subcultures were prepared on TSA slants and incubated at 36±1° C. for 18-24 hours. The growth medium and temperature used were TSA and 36±1° C. Test solutions and test cultures are equilibrated to a test temperature of 20±1° C. in a water bath.

The tests were performed using “dirty” experimental conditions, i.e., 0.3 g/l Bovine Albumin (BA) in-test concentration.

Experimentally, a 1:1 dilution of the test culture and test conditions was performed and allowed to react for 2 minutes. 2.0 mL of the test culture was exposed to 8.0 ml of the test product for a 22-minute contact time and then a 1.0 mL aliquot was neutralized in a verified neutralizer. After a 5-minute neutralization time, the neutralized sample was serially diluted, plated on TSA and incubated at 36±1° C. for 48 hours. The average log 10 CFU/mL for the test suspension was calculated and used to compute the log 10 reduction post-treatment. At least a 5-log 10 reduction of all organisms tested for a 22-minute contact time was chosen to indicate that the tested composition has the desired level of antimicrobial properties against tested organisms. A log 10 reduction greater than 4 means>99.99% reduction in the number of cells; log 10 reduction greater than 5 means>99.999% reduction in the number of cells and denotes complete kill.

The results from the EN1276 antimicrobial efficacy tests are given in Table 2a below.

TABLE 2a

| | | Log₁₀ reduction | | | |
|---|---|---|---|---|---|
| | Concentration | | S. aureus | | P. |
| Sample | (% v/v) | E. coli | ATCC 6538 | E. hirae | aeruginosa |
| C1* | 0.31 | >5.46 | >5.23 | >5.15 | 1.45 |
| | 0.37 | >5.46 | >5.23 | >5.15 | 2.37 |
| | 0.39 | >5.46 | >5.23 | >5.15 | 2.61 |
| | 0.42 | >5.46 | >5.23 | >5.15 | 3.48 |
| C2* | 0.31 | >5.46 | >5.23 | >5.15 | 1.05 |
| | 0.37 | >5.46 | >5.23 | >5.15 | 2.15 |
| | 0.39 | >5.46 | >5.23 | >5.15 | 2.72 |
| | 0.42 | >5.46 | >5.23 | >5.15 | 2.96 |
| C3* | 0.31 | >5.46 | >5.23 | >5.15 | 2.27 |
| | 0.37 | >5.46 | >5.23 | >5.15 | 3.81 |
| | 0.39 | >5.46 | >5.23 | >5.15 | 4.64 |
| | 0.42 | >5.46 | >5.23 | >5.15 | >5.30 |
| C4* | 0.31 | >5.46 | >5.23 | >5.15 | 2.89 |
| | 0.37 | >5.46 | >5.23 | >5.15 | 3.45 |
| | 0.39 | >5.46 | >5.23 | >5.15 | 4.16 |
| | 0.42 | >5.46 | >5.23 | >5.15 | >5.30 |
| E1** | 0.52 | >5.28 | >5.51 | >5.11 | 4.48 |
| | 0.57 | >5.28 | >5.51 | >5.11 | >5.33 |
| | 0.63 | >5.28 | >5.51 | >5.11 | >5.33 |
| | 0.68 | >5.28 | >5.51 | >5.11 | >5.33 |
| E2** | 0.52 | >5.28 | >5.51 | >5.11 | 4.44 |
| | 0.57 | >5.28 | >5.51 | >5.11 | >5.33 |
| | 0.63 | >5.28 | >5.51 | >5.11 | >5.33 |
| | 0.68 | >5.28 | >5.51 | >5.11 | >5.33 |
| E3*** | 0.05 | <2.16 | <2.03 | 2.86 | <1.99 |
| | 0.67 | >5.53 | >5.40 | >5.54 | >5.36 |
| | 0.71 | >5.53 | >5.40 | >5.54 | >5.36 |
| E4**** | 0.20 | 4.22 | >5.50 | >5.48 | <2.11 |
| | 0.70 | >5.54 | >5.50 | >5.48 | >5.48 |
| | 1.18 | >5.54 | >5.50 | >5.48 | >5.48 |

*Tested 2022-using 60-80 mL test samples in 19 L and ATCC 10541 E. hirae
**Tested 2023-using 98-130 mL test samples in 19 L and ATCC 10541 E. hirae
***Tested 2023-using 60-80 mL test samples in 19 L and DSM 3320 E. hirae
****Tested 2023-using 9.5-135 mL test samples in 19 L and DSM 3320 E. hirae

The 0.57 concentration is equivalent to 110 mL in 19 L or 100 mL in 17 L H2O, or approximately 1:170 to 1:172 dilution. The low 0.05% v/v and 0.20% v/v concentrations were included to demonstrate that the test method is reliable. These results demonstrate that the decreased concentration of BKC in samples E1-E4 as compared to samples C1-C4 provide equivalent germ kill efficacy while simultaneously meeting the reduced BKC limits imposed by the European Biocidal Products Regulations (BPR).

Additional testing of E3 and E4 according to EN17658 also passed and are summarized in Table 2b below. One of ordinary skill in the art will recognize that EN1276 is a suspension test, whereas EN17658 simulates real world laundry usage.

TABLE 2b

| | | Log₁₀ reduction | | | | |
|---|---|---|---|---|---|---|
| | Concentration | E. | S. aureus | E. hirae | P. | C. |
| Sample | (% v/v) | coli** | DSM 799 | DSM 3320 | aeruginosa | albicans |
| E3* | 1.18-22 | 4.7 | 3.16 | 3.14 | 3.17 | 3.13 |
| | minutes | | | | | |
| E4* | 1.18-22 | 3.24 | 3.32 | 3.71 | 3.38 | 3.22 |
| | minutes | | | | | |

*average of 3 runs
**ATCC 10536 for E3; DSM 682 for E4

These results demonstrate that E3 and E4 are suitable for use in the rinse phase of the laundry washing process. More specifically, E3 and E4 kill bacteria and yeast in the rinse phase and E3 also kills enveloped viruses.

### Example 3 Comparative Dual Quat Formulation

A comparative formulation containing both BKC and DDAC was prepared and tested to determine stability and efficacy. The comparative formulation is provided in Table 3:

TABLE 3

| Abbreviation | C5 |
|---|---|
| BKC (80%) | 4.78 |
| | (3.82) |
| DDAC | 1.22 |
| | (0.976) |
| CA | 5.2 |
| TNC | 1.3 |
| NaOH (50%) | 0.017 |
| | (0.0085) |
| HPMC | 0.6 |
| D | 0.08 |
| F | 1 |
| Encap | 0.2 |
| H2O | 85.603 |
| Total | 100 |

The resulting formulation C5 exhibited turbidity. The micro results were similar to those of C3 and C4 from Example 2. As a result, utilizing two quaternary ammonium compounds in the formulation does not appear to exhibit increased germ kill efficacy. Additionally, the turbidity of the formulation may present future stability issues.

### Example 4 Softness

The compositions in Table 4 were tested for softness against 33 mL of a commercially available laundry detergent C6 and 25 mL of a commercially available fabric softener C7 with no germ kill ingredients. One of ordinary skill in the art will recognize that larger volumes of the disclosed compositions are required in order to provide germ kill in the laundry rinse process. The test was performed in accordance with ASTM D5237-14 “Standard Guide for Evaluating Fabric Softeners (modified)”.

TABLE 4

| Abbreviation | C8 | E5 |
|---|---|---|
| BKC | 3.04 | 3.04 |
| (80%) | (2.43) | (2.43) |
| CA | 5.2 | 5.2 |
| TNC | 1.3 | 1.3 |
| NaOH | 0 | 0.02 |
| (50%) | | (0.01) |
| HQS | 0.1 | 0 |
| ET | 0 | 0.1 |
| MHEC | 0.53 | 0.525 |
| D | 0.1 | 0.085 |
| F | 1 | 1 |
| Encap | 0.2 | 0.2 |
| H2O | 88.53 | 88.53 |
| Total | 100 | 100 |

### Method

A fabric bundle consisting of cotton towels, pillowcases, and tablecloths was washed with laundry detergent and rinsed using 25 mL of C7 and 100 mL of C8 and E5. After wash/rinse completion, towels were removed and air dried overnight at ambient temperature and humidity. Substrates were then prepared for panel evaluation.

Fifteen (15) individual panelists evaluated the blinded samples based on a Ranking Comparison. Prior to evaluations, each panelist was instructed to wash and dry hands. If re-evaluations were needed, panelists were instructed to evaluate different sections of the towel. Panelists were presented with the tested fabrics on a table, with each fabric presented randomly and containing a different softener treatment and a blinded control. Each of the substrates were ranked with a scale from 1 to 9, with 1 being very rough and 9 being very soft. Results are provided in Table 5 below.

TABLE 5

| | C6 | C7 | C8 | E5 |
|---|---|---|---|---|
| 1 | 3 | 4 | 4 | 4 |
| 2 | 4 | 6 | 4 | 5 |
| 3 | 3 | 5 | 7 | 6 |
| 4 | 3 | 3 | 6 | 5 |
| 5 | 5 | 5 | 6 | 7 |
| 6 | 4 | 7 | 6 | 8 |
| 7 | 3 | 4 | 6 | 7 |
| 8 | 4 | 6 | 7 | 6 |
| 9 | 3 | 3 | 4 | 5 |
| 10 | 4 | 6 | 7 | 6 |
| 11 | 4 | 5 | 3 | 6 |
| 12 | 4 | 7 | 8 | 8 |
| 13 | 4 | 6 | 5 | 6 |
| 14 | 4 | 6 | 7 | 7 |
| 15 | 5 | 6 | 8 | 7 |
| Ave Softness Ranking | 4 | 5 | 6 | 6 |

These results demonstrate that compositions C8 and E5 exhibited superior softness than detergent C6 and softener C7. C8 does not fall within the scope of the disclosed compositions due to the lack of NaOH. However, this example demonstrates that the combination of HQS and MHEC provides equivalent softness to ET and MHEC.

The statistical method applied to these results have been computed using the procedure based on the Anderson-Darling permutation statistic for univariate tests and the nonparametric combination methodology (NPC) after adjustment for multiplicity with Bonferroni-Holm Shaffer method for multivariate tests.

### Example 5 Stability

The composition in Table 6 is currently undergoing stability testing:

TABLE 6

| Abbreviation | E6 |
|---|---|
| BKC (80%) | 3.04 |
| | (2.43) |
| CA | 5.2 |
| TNC | 1.3 |
| NaOH (50%) | 0.017 |
| | (0.0085) |
| MHEC | 0.525 |
| ET | 0.1 |
| D | 0.065 |
| F | 1 |
| Encap | 0.2 |
| H2O | 88.553 |
| Total | 100 |

The initial and 1-week test results are summarized in Table 7:

TABLE 7

| | | | | Viscosity | pH |
|---|---|---|---|---|---|
| Condition | Color | Appearance | Cloudiness | (cPs at 20° C.) | (5%) |
| Initial | Blue | Homogeneous | Opaque | 2300 | 2.6 |
| −10° C. | Blue | Homogeneous | Opaque | 3850 | 2.54 |
| 5° C. | Blue | Homogeneous | Opaque | 2390 | 2.55 |
| 25° C. | Blue | Homogeneous | Opaque | 3440 | 2.54 |
| 30° C./65% RH* | Blue | Homogeneous | Opaque | 3420 | 2.54 |
| 40° C./75% RH* | Blue | Homogeneous | Opaque | 2130 | 2.54 |
| 50° C. | Blue | Homogeneous | Opaque | 900 | 2.54 |
| 60° C. | Blue | Not | Opaque | 110 | 2.55 |
| | | homogeneous**** | | | |
| Freeze/Thaw** | Blue | Homogenous | Opaque | 3570 | 2.53 |
| Windows*** | Blue | Homogeneous | Opaque | 1990 | 2.56 |

*RH = relative humidity
**Freeze/Thaw = 6 days only: 3 cycles of 24 hours each at −10° C. and 25° C.
***Windows = room temperature exposure to sunlight (i.e., in front of a window)
****Physical separation-expected behavior at 60° C.

The initial and 3-week test results are summarized in Table 8:

TABLE 8

| | | | | Viscosity | |
|---|---|---|---|---|---|
| | | | | (cPs at | pH |
| Condition | Color | Appearance | Cloudiness | 20° C.) | (5%) |
| Initial | Blue | Homogeneous | Opaque | 2300 | 2.6 |
| 5° C. | Blue | Homogeneous | Opaque | 3670 | 2.65 |
| 25° C. | Blue | Homogeneous | Opaque | 3515 | 2.63 |
| 30° C./65% RH* | Blue | Homogeneous | Opaque | 2280 | 2.63 |
| 40° C./75% RH* | Blue | Homogeneous | Opaque | 1450 | 2.63 |
| 50° C. | Blue | Homogeneous | Opaque | 310 | 2.63 |
| Windows*** | Blue | Homogeneous | Opaque | 1270 | 2.64 |

*RH = relative humidity
***Windows = room temperature exposure to sunlight (i.e., in front of a window)

### Example 6 Microbicidal Efficacy in Low Temperature Wash Process (≤40° C.)

1 cm² cotton fabric was contaminated with the test microorganisms in bovine serum albumin (BSA). After drying, the cotton fabric was transferred to a tumbling chamber without textile ballast load and was treated with composition E1 from Example 1. 1 cm² cotton fabric that was not contaminated with the test microorganism was also transferred to the tumbling chamber as a control. The tumbling chamber was rotated to simulate a wash process. The fabric was transferred into a neutralizer solution. The number of surviving microorganisms was calculated. The reduction rate was determined by comparing the number of surviving microorganisms on the contaminated fabric versus the number of surviving microorganisms on the control fabric. The reduction rate is the mean or average reduction calculated for 3 tests. Successful disinfection is obtained from a 4 log 10 or greater bacterial reduction (i.e., P. aeruginosa, S. aureus, E. hirae, and E. coli) and 3 log 10 or greater yeast reduction (i.e., C. albicans). The results are provided in Table 9:

TABLE 9

| | Log₁₀ reduction |
|---|---|
| Pseudomonas aeruginosa | 5.16 |
| Gram negative bacterium | |
| ATCC 15442 | |
| Staphylococcus aureus | 5.06 |
| Gram positive bacteria | |
| ATCC 6538 | |
| Enterococcus hirae | 4.60 |
| Gram positive bacteria | |
| ATCC 10541 | |
| Escherichia coli | 5.71 |
| Gram negative bacteria | |
| ATCC 10536 | |
| Candida albicans | 3.41 |
| Gram positive fungus | |
| ATCC 10231 | |

These results demonstrate that the exemplary composition provides laundry disinfection (i.e., germ kill)

Summary of the Sterile carriers/wash water recovery requirements for the test results:
Reduction factor<1.75 log 10—met in all 3 test series
Wash water <1.15 log 10—met in all 3 test series

These results meet the success criteria.

### Example 7—Micro Efficacy Synergies—Amphoteric Surfactants with BKC

The antimicrobial efficacy of the raw materials in Table 10 were screened using F.A.S.T. (Fast Antimicrobial Screening Technology) against Staphylococcus aureus and Pseudomonas aeruginosa. F.A.S.T. is a modified test method based on EN1276. It is a quicker test method that runs many test products simultaneously per plate and can be used for feasibility studies. For the purposes of our test methods, the turbidity method was utilized. A 96 well plate was set up and neutralizer media was pipetted into column 2 of the plate. Growth media was pipetted into columns 3-12. A control of either AOAC or EN lab purified sterile water was added to column 1 in at least duplicates. Test products were added to open rows in column 1 in at least duplicates. Up to 4 products, including the control, can be tested on a single plate. Bacterial suspension was mixed with certain conditions depending on product usage. To mimic the laundry rinse cycle, solutions were kept around 20 C and 0.3 g/L bovine albumin was added to the bacterial suspension. After 2 minutes, the bacteria solution was transferred into wells in column 1 using a multi-channel pipet. The solutions in each well were mixed by pipetting up and down. After the designated contact time has expired, column 1 solutions were transferred into the wells with neutralizer and pipet to mix. A contact time of 25 minutes was used to mimic the laundry rinse cycle. The neutralized solution was then transferred in column 3 with growth media and mixed. Solutions in column 3 were then serially diluted 1:10 into the remaining wells with growth media. The plate was covered and added to an incubator overnight. Wells that show turbidity were used to estimate bacteria log₁₀ reduction. The Spearman-Karber method (Eq. 1) was used to calculate the log₁₀ recovery.

$${Log}_{10} recovery = Highest dilution ( HD ) with both positives - 0.5 + ( sum of positive wells at HD and up ) / 2.$$

TABLE 10

| Formula | C9 | C10 | C11 | C12 | C13 |
|---|---|---|---|---|---|
| 9EO | 6.58 | 0 | 0 | 0 | 0 |
| | (6.25) | | | | |
| SLES | 0 | 23.58 | 0 | 0 | 0 |
| | | (6.25) | | | |
| CocoB | 0 | 0 | 6.58 | 0 | 0 |
| | | | (6.25) | | |
| APG | 0 | 0 | 0 | 12.39 | 0 |
| | | | | (6.25) | |
| LO (30%) | 0 | 0 | 0 | 0 | 21.26 |
| | | | | | (6.25) |
| H2O | q.s. | q.s. | q.s. | q.s. | q.s. |
| Staphylococcus | 0 | 0 | 0 | 0 | 2 |
| aureus log₁₀ | | | | | |
| reduction | | | | | |
| Pseudomonas | 0 | 0 | 0 | 0 | 0 |
| aeruginosa | | | | | |
| log₁₀ reduction | | | | | |

Table 10 demonstrates that most surfactants do not contribute to micro efficacy, but some amphoteric surfactants such as Lauramine Oxides can contribute to reducing bacteria levels. The samples targeted 6.25% wt in solution and were further diluted during testing to a final active level of about 5%. Only the sample with Lauramine Oxide showed a log 10 reduction against Staphylococcus aureus. Findings from this study were utilized in full laundry sanitizer formulas.

### Example 8 BKC Polyquaternium (PQ) Antimicrobial Synergy

### Inoculum Preparation:

Take well-defined and typical colonies of Staphylococcus epidermidis from a recent plate of tryptic soy agar (TSA), dissolve and vortex them in a tube containing 30 mL of tryptic soy broth (TSB) and incubate for 17+/−1 h at 37° C.+/−1° C. Quantify by plate count in TSA (incubated for 48 h+/−1 h at 37° C.+/−1° C.). Use the broth culture suspension within seven (7) days after the incubation period. Vortex and take 0.2 mL from the broth culture and dilute in appropriate volume of 0.85% NaCl to normalize the strain at 3-5×10\hat{ }5 CFU/mL

### Test Sample Gradient Creation:

Using a micropipette, add 100 μL of TSB in a 96-well microtiter plate format.

Dispense 100 μL of the test sample (polymer) in column 1 (from row A to row H depending on the number of test samples) and 100 μL of the same test sample (polymer) in column 2 in their respective rows within 30 minutes of preparing the solution if it has been previously diluted. (both samples are the same)

Using a micropipette take 100 μL of the sample from column 2 and dilute it in column 3 performing a 1:1 dilution with the diluent already present in the wells, proceeding with a serial dilution up to column 9. Discard the remaining 100 μL.

### Inoculum:

Within 30 minutes of preparing the gradient and inoculum bacterial suspension, dispense 20 μL of a solution of BKC in the wells from columns 2 to 9. Dispense 100 μL of inoculum using a micropipette into each well in columns 2 to 10. Columns 1 and 11 are the sample sterility test and negative test control columns, respectively. No growth should be observed in these columns. Column 10 is the positive test control and growth should be observed.

To test the polymers antimicrobial activity alone (without BKC) repeat the steps above, without the addition of the 20 μL solution of BKC.

The inoculum must be between 2.5-4.5×10\hat{ }5 CFU/mL in each well.

Incubate the microwell plate for 24 h+/−1 h at 37° C.+/−1° C.

The minimum inhibitory concentration (MIC) is determined by visually checking the wells for growth. The MIC is defined as the minimal concentration of polymer in the corresponding well without visible growth after 24 hours of incubation. The tests were performed two times for most of the listed polyquaternium polymers. The MIC of BKC alone ranged from 5-8 ppm or 0.3-0.8 ppm in R&D test conditions. One of ordinary skill in the art will recognize that micro testing is not an exact science and results may vary significantly, especially in R&D test conditions. However, these results demonstrate the consistent synergy or lack of synergy between BKC and the polymers. The results are provided in Table 11:

TABLE 11

| | BKC | BKC MIC | Polymer | Polymer |
|---|---|---|---|---|
| | MIC in | in ppm | MIC in | MIC in |
| | ppm | with | ppm with | ppm |
| | alone | polymer | BKC | alone |
| PQ6 | 5-8 | 4 | 0.8 | 6.25-40 |
| <100 kDa | 0.3-0.8 | 0.075 | 2 | 7.8 |
| PQ6 | 5-8 | 4 | 0.8 | 6.25-40 |
| 200-300 kDa | 0.3-0.8 | 0.075 | 2 | 7.8 |
| PQ6 | 5-8 | 4 | 0.8 | 6.25-40 |
| 400-500 kDa | 0.3-0.8 | 0.075 | 3.9 | 15.6 |
| PQ7 | 5-8 | 4 | 39 | 1250 |
| | 0.3-0.8 | 0.075 | 250 | >250 |
| PQ16 | 5-8 | 4 | 0.8 | 8-12.5 |
| 5VP-95QVI | 0.3-0.8 | 0.075 | 3.9 | 15.6 |
| PQ16 | 5-8 | 4 | 0.8 | 25-47 |
| 50VP-50QVI | 0.3-0.8 | 0.075 | 15.6 | 62.5 |
| PQ16 | 5-8 | 4 | 39 | 1250 |
| 70VP-30QVI | 0.3-0.8 | 0.075 | >250 | >250 |
| A1000 | 5-8 | 4 | 0.8 | 12-16 |
| | 0.3-0.8 | 0.075 | 3.9 | 23.4 |
| PQ28 | 5-8 | 4 | 0.8 | >2500 |
| | 0.3-0.8 | 0.075 | >250 | >250 |
| C113 | 5-8 | 4 | 0.8 | 12.5-16 |
| | 0.3-0.8 | 0.075 | 3.9 | 31.2 |
| PQ37 | 5-8 | 4 | N/A | 31 |
| | 0.3-0.8 | 0.075 | 15.6 | 31.2 |

* All ppm show 100% wt concentration of active, not % wt raw material
** N/A = not analyzed

As shown in Table 11 above, all 3 kDa of PQ6, PQ16 5VP-95QVI, A1000, and C113 exhibit excellent synergy with BKC, especially PQ6<100 kDa and PQ6 200-300 kDa. The combinations permit the disclosed disinfecting concentrations to significantly reduce the quantity of BKC without adding a large quantity of the polymer to the disinfecting compositions.

PQ16 50VP-50QVI and PQ37 also demonstrate synergy, but require a larger quantity of polymer to do so.

PQ7, PQ16 70VP-30VPI and PQ28 require a large quantity of polymer to increase the efficacy of BKC. And BKC is inexpensive. As a result, these polyquaternium polymers may be undesirable to use to increase the germ kill of benzyl-substituted quaternary ammonium compounds, especially if they are toxic to aquatic environment.

The foregoing description of various aspects of the invention has been presented for purposes of illustration and description. Embodiments and/or features therein may be freely combined with one another. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A composition comprising 2% wt to 4% wt of a benzyl-substituted quaternary ammonium compound; three or more pH adjusters, the pH adjusters being selected from the group consisting of citric acid, sodium citrate, an alkali hydroxide or alkali carbonate, and combinations thereof, wherein the composition is substantially free of dialkyl dimethyl ammonium chloride.

2. The composition of claim 1, wherein the benzyl-substituted quaternary ammonium compound is C12-18 alkyl dimethyl benzyl ammonium chloride.

3. The composition of claim 1, wherein the composition comprises 4% wt to 6% citric acid.

4. The composition of claim 1, wherein the composition comprises 0.8% wt to 2% wt sodium citrate.

5. The composition of claim 1, wherein the composition comprises 0.005% wt to 0.03% wt of the alkali hydroxide or alkali carbonate.

6. The composition of claim 1, further comprising water.

7. The composition of claim 1, further comprising 0.1% wt to 1% wt of a cellulose based material selected from the group consisting of hydroxyethylcellulose; methylhydroxyethylcellulose; fermentation derived cellulose; a blend of hydropropylmethylcellulose, xanthan gum, and cetyl-hydroxy ethyl cellulose; and combinations thereof.

8. The composition of claim 7, wherein the cellulose based material is methylhydroxyethylcellulose.

9. The composition of claim 7, wherein the composition comprises 0.75% wt to 1.25% wt of a fermentation derived cellulose and 0.45% wt to 0.75% wt of a hydroxyethylcellulose.

10. The composition of claim 7, wherein the composition comprises 0.1% wt to 2% wt of methylhydroxyethylcellulose and 0.005% wt to 1.5% wt of a blend of hydropropylmethylcellulose, xanthan gum, and cetyl-hydroxy ethyl cellulose.

11. The composition of claim 1, further comprising 0.05% wt to 1% wt, preferably from 0.05% wt to 0.2% wt, of a fabric softener, conditioner, and/or protector.

12. The composition of claim 11, wherein the fabric softener, conditioner, and/or protector comprises or consists of stearyldimonium hydropropyl hydrolyzed wheat protein.

13. The composition of claim 11, wherein the fabric softener, conditioner, and/or protector comprises or consists of a copolymer of hydrolysed wheat protein and silicone.

14. The composition of claim 1, further comprising an enzyme selected from the group consisting of cellulase, protease, phosphodiesterase, and combinations thereof.

15. The composition of claim 14, wherein the enzyme is phosphodiesterase.

16. A method of sanitizing laundry during a laundry washing process, the method comprising adding from 30 mL to 180 mL of the composition of claim 1 to the fabric softener compartment of an automatic washing machine and using the automatic washing machine to perform a laundry washing process.

17. The method of claim 16, wherein the process further softens the laundry.

18. The method of claim 16, wherein the composition comprises 4% wt to 6% citric acid, 0.8% wt to 2% wt sodium citrate, 0.005% wt to 0.03% wt of the alkali hydroxide, and water.

19. The method of claim 18, wherein the composition further comprises 0.1% wt to 1% wt of a cellulose based material selected from the group consisting of hydroxyethylcellulose; methylhydroxyethylcellulose; fermentation derived cellulose; a blend of hydropropylmethylcellulose, xanthan gum, and cetyl-hydroxy ethyl cellulose; and combinations thereof/

20. The method of claim 18, wherein the composition further comprises 0.05% wt to 1% wt, preferably from 0.05% wt to 0.2% wt, of a fabric softener, conditioner, and/or protector.
